(19) United States
(12) Patent Application Publication
(10) Pub. No.: US 2019/0205317 A1
(43) Pub. Date: Jul. 4, 2019

(54) SYSTEMS AND METHODS FOR SECURE STORAGE AND RETRIEVAL OF DATA OBJECTS

(71) Applicant: FHOOSH, INC., La Jolla, CA (US)

(72) Inventors: Eric TOBIAS, La Jolla, CA (US); Anthony IASI, San Diego, CA (US); Charles KAHLE, Escondido, CA (US); Gary SCHNEIR, Carlsbad, CA (US); John TYNER, San Diego, CA (US)

(21) Appl. No.: 16/296,123

(22) Filed: Mar. 7, 2019

Related U.S. Application Data
(63) Continuation-in-part of application No. 15/622,026, filed on Jun. 13, 2017.
Application No. 15/622,026 is a continuation-in-part of application No. 15/605,860, filed on May 25, 2017.
Application No. 15/605,860 is a continuation of application No. 14/061,736, filed on Oct. 23, 2013, now Pat. No. 9,665,638.
(60) Provisional application No. 62/640,485, filed on Mar. 8, 2018.
(60) Provisional application No. 61/857,177, filed on Jul. 22, 2013.
(60) Provisional application No. 61/720,907, filed on Oct. 31, 2012.
(60) Provisional application No. 61/720,916, filed on Oct. 31, 2012.
(60) Provisional application No. 61/720,309, filed on Oct. 30, 2012.
(60) Provisional application No. 61/720,305, filed on Oct. 30, 2012.
(60) Provisional application No. 62/349,567, filed on Jun. 13, 2016.
(60) Provisional application No. 62/350,646, filed on Jun. 15, 2016.

(51) Int. Cl. G06F 16/28; G06F 16/9535; G06F 16/35; G06F 16/335; G06F 16/00; G06Q 30/02; G06F 21/60; G06F 17/24; H04W 4/08; H04L 29/08; G06F 3/0487

(52) U.S. Cl. CPC G06F 16/285; G06F 16/9535; G06F 16/355; G06F 16/337; G06F 16/00; G06Q 30/0269; G06F 21/60; G06F 17/243; H04W 4/08; H04L 67/30; G06F 3/0487; G06Q 30/0204

(57) ABSTRACT

Systems and methods for storing, accessing and management a data object are provided. The systems comprise: a trusted file manager system comprising a plurality of data repositories corresponding to a plurality of storage locations configured to store encrypted data fragments; a secure server; and a client device comprising and an application running on the client device and one or more processors, the application communicatively coupled to the secure platform and the trusted file manager system.

### CROSS-REFERENCE TO RELATED APPLICATION(S)

This application is a continuation-in-part of U.S. patent application Ser. No. 15/622,026, filed on Jun. 13, 2017, which is a continuation-in-part of U.S. application Ser. No. 15/605,860, filed on May 25, 2017, which is a continuation of U.S. application Ser. No. 14/061,736, filed on Oct. 23, 2013, now U.S. Pat. No. 9,665,638, granted May 30, 2017, which claims priority to U.S. Provisional Application Nos. 61/857,177, filed on Jul. 22, 2013, 61/720,907, filed on Oct. 31, 2012, 61/720,916, filed on Oct. 31, 2012, 61/720,309, filed on Oct. 30, 2012, and 61/720,305, filed on Oct. 30, 2012, the disclosures of all of which are incorporated herein in their entireties by reference. U.S. patent application Ser. No. 15/622,026 also claims the benefit of U.S. Provisional Application No. 62/349,567, filed Jun. 13, 2016, and U.S. Provisional Application No. 62/350,646, filed Jun. 15, 2016, the disclosures of which are incorporated herein in their entireties by reference. This application also claims the benefit of U.S. Provisional Application No. 62/640,485, filed Mar. 8, 2018, the disclosure of which is incorporated herein in its entirety by reference.

This application is related to U.S. patent application Ser. No. 15/806,058, filed on Nov. 7, 2017, U.S. patent application Ser. No. 15/411,888, filed on Jan. 20, 2017, U.S. patent application Ser. No. 14/863,294, filed on Sep. 23, 2015, U.S. patent application Ser. No. 14/970,466, filed on Dec. 15, 2015, and now U.S. Pat. No. 10,165,050, granted on Dec. 25, 2018, the disclosures of which are incorporated herein in their entirety by reference.

### BACKGROUND

### 1. Field

Various embodiments described herein relate generally to the field of electronic management of information, and more particularly to secure storage and protection of user information in a user profile. Further, various embodiments described herein relate generally to the field of electronic data security and more particularly to the secure storage, management, and transmission of data, credentials and encryption keys at a client endpoint and during transmission.

### 2. Related Art

The vision of a paperless modern society is quickly becoming a reality, as more and more communications, services and transactions take place digitally across networks such as the Internet. The need for paper copies of correspondence, financial documents, receipts, contracts and other legal instruments is dwindling as electronic methods for securely transmitting, updating and accessing these documents increases. In addition to the electronic transmission and access to documents and correspondence, the process of electronically submitting information is also commonplace, such as with online shopping or applications for loans, credit cards, health insurance, college or job applications, etc.

Security of electronic data is of paramount importance for private individuals and for almost every conceivable business and government entity. A tremendous volume of electronic data is being generated, stored, and transmitted on a constant basis. Moreover, the breadth of electronic data, which nowadays inevitably extends to private and sensitive information, necessarily attracts a host of bad actors.

Conventional data security solutions are relatively static. For example, one or more data security mechanisms (e.g., password protection, encryption scheme) may be deployed at a particular data storage location. The same data security mechanisms will generally remain in place until a significant security breach is detected, at which point the entire data storage location may have already been compromised.

Data that have been stored based on standard relational data models are particularly vulnerable to unauthorized access. Individual data records (e.g., name, address, social security number, credit card number, and bank account number) stored in separate storage locations are typically accompanied by a common record locator indicating a logical nexus between the data records (e.g., associated with the same user). For example, individual data records may each be associated with the same user identification number. As such, unauthorized access to any one data record may expose sufficient information (i.e., the user identification number) to gain access to the remainder of the data records.

Although numerous data security methods are available, implementing a flexible roster of seamlessly integrated and complementary data security solutions at a single data storage location remains an enormous challenge. For example, while combining security solutions will normally increase data security, incompatibilities between different solutions may in fact give rise to additional security risks.

Moreover, in order for a user to be able to store and retrieve data, there must be a way to identify that user and protect their data from being accessed by any other user. Traditionally, this is performed by “front-end” software where the user is authenticated and authorized through a login process.

The conventional login process is associated with a number of documented weaknesses. For example, in many systems, the login step is commonly considered a part of the user interface (UI) and a separate entity from the security bubble. The problem is magnified in cases where in-house developers, having limited background in security, attempt to build custom login authentication and authorization systems. As such, a malicious user can potentially have access to other users' data once that user successfully completes the login process.

But these issues are also exacerbated by the fact that much of the data that is created today is created or accessed at a client endpoint, e.g., a computer, laptop, smartphone, tablet, Internet of Things device, etc. Even if the issues described above can be solved for data stored and retrieved at a server, there is the additional problem of securing the data at the endpoint. Thus, any solution to the above issues should take into account the fact that the client endpoint must also be secured.

### Key Exchange Methodologies

There are many forms of key exchange methodologies in current use for establishing a trusted communication link between two devices and to encrypt/decrypt transmitted data such as through symmetric shared secret keys or public/private asymmetric keys. Symmetric encryption uses the same key for both encrypting and decrypting data through any number of algorithms such as AES, Blowfish, DES, and Skipjack and is typically faster than asymmetric encryption. It is often used for bulk data encryption and when high rates of data throughput are necessary. In contrast, asymmetric encryption utilizes a pair of keys, public and private, where a public key is typically used to encrypt the data and the private key is used to decrypt the data. Asymmetric key algorithms can be 1000 times slower than symmetric key algorithms and therefore more commonly applied to key management or initial device authentication where there is not a continuous exchange of key pairs which would require enormous resource capability.

### Encrypted Data Transmission

In a common scenario where a large object needs to be sent encrypted to multiple client destinations and each client should have a uniquely encrypted copy, the traditional approach is to encrypt the original object using a different key for each client. If there are N clients and it takes an amount of time T to encrypt each object, the total encryption time is N×T.

### Data Encryption Speed

Currently, there are several approaches to increase performance (speed at which data can be encrypted). One approach is by using hardware-based acceleration. 128 bit and 256-bit AES ciphers can be accelerated 4 to 8 times through AES-NI hardware encryption (where available on Intel and AMD processors). It is also possible to decrease the key size at the expense of security. AES with 256-bit keys is about 40% slower than AES with 128-bit keys. Another tactic is to use alternative encryption algorithms such as Blowfish which can produce a 20% speed improvement.

### Encryption Key Management

Encryption keys are typically used to encrypt data or to encrypt other keys which are then used to encrypt data, the later commonly known as Key Encryption Keys (KEK). Managing keys and who has access to keys can be a daunting task. Key Management Software (KMS) attempts to make this job easier by providing user and administration access to all of the necessary keys. A KMS may also provide backup and redundancy services to safeguard a copy of the keys in case of a catastrophic server failure. User uptime is maintained when a replacement KMS is spun up quickly since access to encrypted data will not be possible unless the KMS is constantly up.

### Compound Security Keys

The concept of compound security keys is widely known and used in many scenarios. For example, a compound key for Alice and Bob to unlock a file affords them the ability to unlock the file but only if both of them unlock it in concert. Nether Bob or Alice can independently unlock the file. These compound keys are typically static and must be re-written by an administrator when a change is required.

### Data Access Restriction

When access to data needs to be restricted, a commonly used approach is to configure access rights at the user level and/or establish groups of users each having different roles and permissions assigned to them. This ensures that user A, for example, does not have access to User B's data. Another approach commonly used for databases is to develop database query statements that check for any number of restrictions before allowing access to the data. The problem with all these solutions is that they do not provide an easy way to have granular control at the data item level and these restrictions themselves are not universally encrypted.

### Hacking

Hackers spend an average of 200 days in a system before they are discovered. While inside, they observe traffic and make various attempts at locating additional credentials, usernames, passwords, etc. Access logs and behavioral analytics are some ways that detection efforts are focused on. In addition, “honey pot” files, databases, or servers are strategically placed in an attempt to slow down hackers.

### Ransomware

Ransomware is software surreptitiously installed on a computer that executes an encryption algorithm applied to all files visible to that computer, including those on network connected drives and cloud folders. The intent is to make the affected files unusable unless the victim pays a ransom amount at which point a decryption key is provided. There are products that attempt to identify early signs of an attack based on characteristics such as the appearance of files with extensions known to be generated by ransomware software or large number of file renaming activity. Another approach includes click-blocking software that prevents users from clicking on attachments in emails (the largest source of attacks). Finally, there are many malware solutions that monitor unusual running processes that could be a sign that there is an infection.

The most effective solution to protect against ransomware is to backup all files regularly ensuring that there are several days' worth of backups. There are a variety of products that run backups on an automatic schedule. However, many backup systems use a mounted drive for the backup. If the ransomware virus can see your files, it can see all of your drives including the one being used for backups. There are ways to protect the backup drive such as setting up proper access credentials and protocols. Being that ransomware is continually evolving and adapting, many of these solutions have been losing ground to the criminals.

### Searching Encrypted Data

There are a number of approaches for searching on encrypted data such as pre-indexing search fields or homomorphic encryption that allows evaluations and therefore searching on encrypted data. The greatest challenge is maintaining performance within acceptable limits and every method either slows the search process down or introduces a security weakness. In any case, these methods vary widely in implementation rarely following standards. These custom implementations make it difficult to leverage third party search tools.

### Data Encryption

Data is traditionally encrypted while in any number of states. For example, an entire hard-drive may be encrypted for data-at-rest. In another example, data-in-motion may be encrypted as it travels through a secure https connection. Data in databases may also be encrypted using methods where data in individual fields are encrypted in place while preserving the original table format. Other ad-hoc scenarios include encrypting single desktop folders or mounted disk drives.

In all these cases, the data to be encrypted is not organized into a format that is much different from their original footprint. The encrypted data merely replaces the original data in-place, or if replicated to other media, transferred to storage using a similar data and file hierarchy as the original data. Other techniques exist which do reorganize the data storage format, such as in the case with Data Sharding and Erasure Coding algorithms. These distribute the original data and that data may also be encrypted. However, the distribution and storage formats follow a rigid protocol imposed by the underlying algorithm thereby making it difficult to apply higher level capabilities and integration with existing legacy formats and/or third-party solutions.

### SUMMARY

Disclosed herein are systems and methods for secure storage, transmission and management of data, credentials and encryption keys to and from the client endpoint. According to one aspect a system for storing a data object is provided. The system comprises: a trusted file manager system comprising a plurality of data repositories corresponding to a plurality of storage locations; a secure server; and a client device comprising and an application running on the client device and one or more processors, the application communicatively coupled to the secure platform and the trusted file manager system. The application is configured to: select a data repository, the data repository associated with a data map of one or more of the plurality of storage locations corresponding to the data repository, and send a request to store the data object with the data repository, wherein, in response to the request to store the data object, the data object is disassembled into a plurality of data fragments, the plurality of data fragments are individually encrypted, and the encrypted data fragments are stored to the one or more of the plurality of storage locations in accordance with the data map.

In another aspect, a system for accessing a data object is provided. The system comprises: a plurality of storage locations configured to store encrypted data fragments; a trusted file manager system comprising a plurality of data repositories each associated with a data map of one or more of the plurality of storage locations corresponding to a respective data repository; a secure server; and a client device comprising and an application running on the client device and one or more processors, the application communicatively coupled to the secure platform and the trusted file manager system. The application is configured to: select a data repository, the data repository comprising at least the data object, and send a request to access the data object from the selected data repository, wherein, in response to the request to access the data object, a plurality of encrypted data fragments are retrieved from the one or more of the plurality of storage locations in accordance with the data map associated with the data repository, the plurality of encrypted data fragments are decrypted, and the data object is reassembled from the decrypted data fragments.

In another aspect, a system for managing storage and access to a plurality of data objects is provided, the system comprising: a plurality of storage locations configured to store encrypted data fragments of the plurality of data objects; a trusted file manager system comprising a plurality of data repositories, each associated with a data map of one or more of the plurality of storage locations corresponding to a respective data repository; a secure server; and a client device comprising and an application running on the client device and one or more processors, the application communicatively coupled to the secure platform and the trusted file manager system. The application is configured to: create a data repository and an associated data map of one or more of the plurality of storage locations configured to store a plurality of encrypted data fragments of a data object, identify a storage location of the plurality of storage locations to store a manifest usable to decrypt the plurality of encrypted data fragments, and associate the data repository with one or more users.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments. It should be noted that for clarity and ease of illustration these drawings are not necessarily made to scale.

FIG. 1 is a reproduction of FIG. 1 of U.S. application Ser. No. 14/863,294, the disclosure of which application incorporated herein in its entirety by reference;

FIG. 2 is a reproduction of FIG. 1 of U.S. application Ser. No. 14/970,466, the disclosure of which application is incorporated herein in its entirety by reference;

FIG. 3 is a reproduction of FIG. 1 of U.S. application Ser. No. 15/411,888, the disclosure of which application is incorporated herein in its entirety by reference;

FIG. 4 is a reproduction of FIG. 3 of U.S. application Ser. No. 15/806,058, the disclosure of which application is incorporated herein in its entirety by reference;

FIG. 5 is a reproduction of FIG. 4 of U.S. application Ser. No. 15/411,888;

FIG. 6 is a flowchart illustrating a method for exchanging keys in accordance with various aspects of the present disclosure;

FIG. 7 is a sequence diagram illustrating an encrypted data transmission sequence in accordance with various aspects of the present disclosure;

FIG. 8A is a flowchart illustrating a method for pre-slicing data to increase encryption speed in accordance with various aspects of the present disclosure;

FIG. 8B is a flowchart illustrating a method recombining a data file in accordance with various aspects of the present disclosure

FIG. 9 is a flowchart illustrating a method for managing encryption keys in accordance with various aspects of the present disclosure;

FIG. 10 is a flowchart illustrating a method for evaluating a compound key in accordance with various aspects of the present disclosure;

FIG. 11 is a flowchart illustrating a method for restricting data access in accordance with various aspects of the present disclosure;

FIG. 12 is a flowchart illustrating a method for detecting and responding to hacking attacks in accordance with various aspects of the present disclosure;

FIG. 13 is a flowchart illustrating a method for detecting and responding to ransomware attacks in accordance with various aspects of the present disclosure;

FIG. 14 is a flowchart illustrating a method for enabling searching on encrypted data in accordance with various aspects of the present disclosure;

FIG. 15 is a flowchart illustrating a method for utilizing a virtual cryptological container for storing encrypted data in accordance with various aspects of the present disclosure;

FIG. 16 is a diagram illustrating a system 700 including a VFS 720 in accordance with various aspects of the present disclosure

FIGS. 17A-17K illustrate example screen shots of graphical user interface of interacting with the application installed onto the user device, through which a user can interact with the VFS in accordance with the disclosure here;

FIGS. 18A-18I illustrate example screen shots of graphical user interface of interacting with the application installed onto the user device, through which a user can interact with the VFS in accordance with the disclosure here; and

FIGS. 19A-19D illustrate example screen shots of graphical user interface of interacting with an application installed onto the user device, through which a user can interact with the systems in accordance with the disclosure herein.

The various embodiments mentioned above are described in further detail with reference to the aforementioned figures and the following detailed description of exemplary embodiments.

### DETAILED DESCRIPTION

Certain embodiments disclosed herein provide methods and systems for secure storage and management of data, credentials and encryption keys, specifically including client endpoint protection. After reading this description it will become apparent how to implement the embodiments described in various alternative implementations. Further, although various embodiments are described herein, it is understood that these embodiments are presented by way of example only, and not limitation. As such, this detailed description of various alternative embodiments should not be construed to limit the scope or breadth of the appended claims.

Co-pending U.S. patent application Ser. No. 14/863,294 (the '294 Application), the disclosure of which is incorporated herein by reference in its entirety as if set forth in full. The '294 Application describes systems and methods for secure high-speed data storage, access, recovery and transmission that involves fragmenting, individually encrypting and dispersing of the data as described therein. For example, as described in the '294 Application, data in a medical record can first be disassociated so that, e.g., the various fields are not logically related. Then the disassociated fields can be decomposed into sub-fields or parts (fragments). These sub-fields can then be obfuscated such that one cannot easily determine the contents of the sub-fields, even if they were to intercept or gain access to them. These sub-fields can then be individually encrypted, e.g., using a different encryption key for each sub field or fragment. The individually encrypted, sub fields can then be “sharded” and stored on different storage devices or locations.

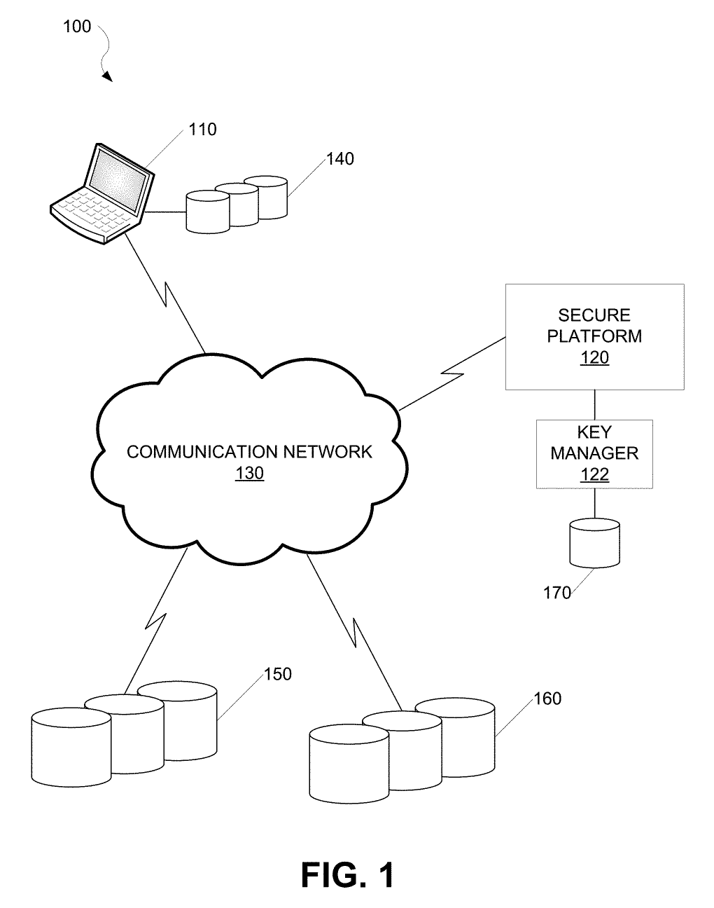

FIG. 1 is a reproduction of FIG. 1 of the '294 Application illustrates an example system on which the process described can be carried out. But as described, with reference to FIG. 1, the process generally occurs on secure platform 120 in response to a command or request initiated on client device, or endpoint 110. The secure platform 120 then stores the encrypted fragments on various storage devices or locations 140-170. While location 140 can be local or locally connected to device 140, the processes described in the '294 Application do not necessarily cover the link from endpoint 110 to platform 120.

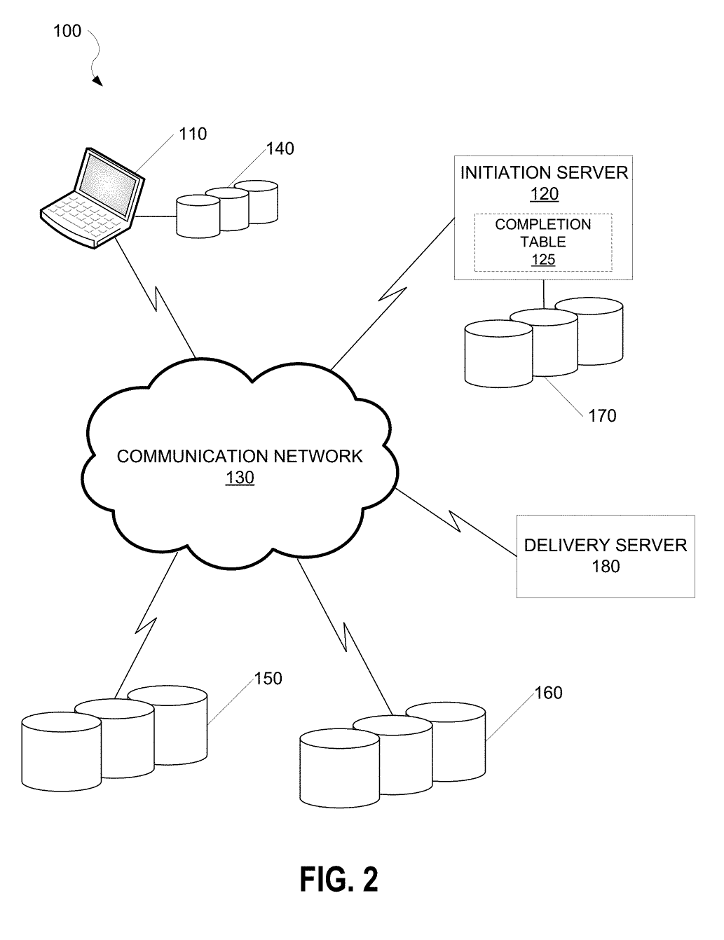

Co-pending U.S. patent Application Ser. No. 14/970,466 (the '466 Application), the disclosure of which is incorporated herein by reference in its entirety as if set forth in full and describes systems and methods for diffracted data retrieval of data that has gone through the processes of the '294 Application. FIG. 2 is a reproduction of FIG. 1 of the '466 Application which illustrates a system for carrying out the diffracted data retrieval described therein. As described with reference to FIG. 2, while the diffracted data retrieval can involve storage device or location 140 which is local or locally connected to endpoint 110, the processes described therein generally do not apply to the link between endpoint 110 and servers 120 and 180.

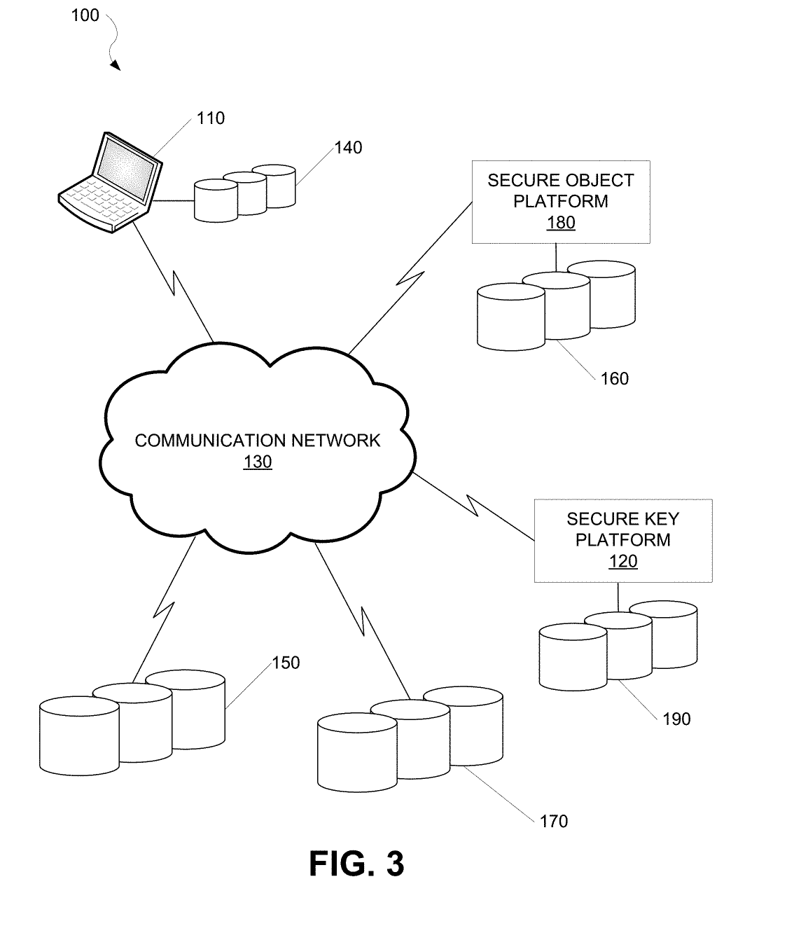

U.S. patent application Ser. No. 15/411,888 (the '888 Application), now expired, the disclosure of which is incorporated herein by reference in its entirety as if set forth in full. The '888 Application describes systems and methods for secure storage and management of credentials and encryption keys. FIG. 3 is a reproduction of FIG. 1 the '888 Application which illustrates a system on which the processes described therein can be carried out. As described with reference to FIG. 3, while the secure storage and management of credentials and encryption keys can involve storage device or location 140 which is local or locally connected to endpoint 110, the processes described therein generally do not apply to the link between endpoint 110 and servers 120 and 180.

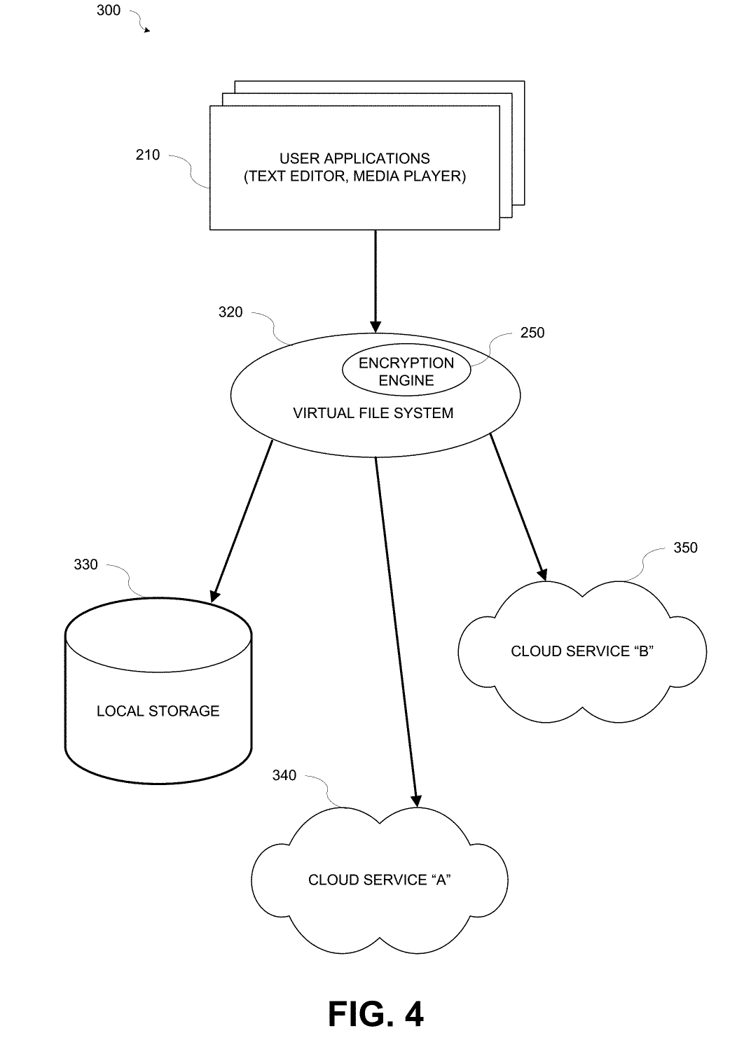

U.S. patent application Ser. No. 15/806,058 (the '058 Application), the disclosure of which is incorporated herein by reference in its entirety as if set forth in full and describes systems and methods for storage of data that has gone through the processes of the '294 Application. FIG. 4 is a reproduction of FIG. 3 of the '058 Application which illustrates a system for storing data with a virtual file system described therein. As described with reference to FIG. 4, while the storage of data within the virtual file system involves storing data fragments at different locations within the virtual file system which can be mapped to virtual cryptological containers, the processes described therein generally do not apply to the link between endpoint 110 and servers 120 and 180. The virtual file system may also be referred to as a trusted file manager system and the virtual cryptological containers may be referred to as data repositories, and usage of either phrase throughout the present disclosure applies equally to both all embodiments herein. Virtual cryptological containers may be abstractions of the actual physical storage locations so to virtually map and associate storage locations for distributing data fragments. In this way, users of the system may think about the distributed data fragments as stored in a single virtual location or container that is in actuality mapped to plurality of storage locations.

U.S. patent application Ser. No. *** (the '*** Application), the disclosure of which is incorporated herein by reference in its entirety as if set forth in full and describes systems and methods for storage of data that has, for example, gone through the processes of the '294 Application and is stored on a local or locally connected storage device (e.g., referred to herein as “on-premise” storage of encrypted data), as well as transmission of a data team of encrypted data to a remote client endpoint device. With reference to FIG. 1, the '*** Application describes storage of a local storage device or location 140 which is local or locally connected to endpoint 110 for on-premise storage of encrypted data, as well as transmission of encrypted data to a remote endpoint via a data stream, and management of key for decrypting the encrypted data.

In the systems and methods described herein, the process described in the '294, '466, '888, '058, and '*** Applications can be implemented at the edge, i.e., on client endpoint 110 as illustrated in FIGS. 1-4. For example, an application can be loaded to device 110, such that data can be saved to and retrieved from different portions of local or locally connected storage device 140 as described in the Attachments or such that the data can be saved and stored to a plurality of storage devices 140-170. Thus, if the user of device 110 creates a document, video, picture, etc., the user can invoke to the application to store the document or file. This can involve doing all the steps described above and, in the Attachments, to store the fragments in a dispersed manner to different locations in storage device 140 or to different locations on memories 140-170 as described above and, e.g., in the '294 Application. Similarly, the application can perform the diffractive retrieval of the data or file as described in '466 Application, and can enforce the management of credentials and encryption keys as described in '888 Application.

Thus, when the data is saved to a plurality of storage devices, the transmission of that data to those devices is also secured via the fact that the process separately encrypted all the fragments prior to transmission for storage. In other words, the data elements are all fragmented and secured at the device before they are transmitted, for example, as described in the '*** Application. A major benefit of this is that the communication channel does not need to be secured and an ordinary “open” connection can be used. For example, instead of using the slower and more expensive TLS secured browser transmission, a faster non-encrypted channel may be used. The data packets will contain secured fragments. This applies to all types of transmission, not just browser based: could be radio, FTP, Bluetooth, etc.

The application can be presented as button in a toolbar or drop-down menu such that when the user is in a document or file on their device 110 as illustrated in FIGS. 1-4, they can simply press the button, icon, etc., in the associated application or in a web browser and the document can be stored accordingly. The document or file can then be shown on device 110 in a manner that indicates that it has been stored using the processes describe above and in the '294, '466, '888, '058, and/or '*** Applications. When the user accesses the document or file again, the retrieval process described above and in the '294, '466, '888, '058, and/or '*** Applications can automatically take place. In certain embodiments, the user can also select various dispersion preferences as to where all, or some of the fragments are stored.

In other embodiments, e.g., a right click on a file can be used to select the storage processes described. In still other embodiments, the application can automatically determine that a file should be stored using such processes. In still other embodiments, the default for all files, certain files, certain types of files, etc., can be set to use such processes.

Often, a user of device 110 as illustrated in FIGS. 1-4 will ultimately want to use some form of remote storage, often referred to as cloud storage to store at least some of the files created on device 110. An application(s) running on a server(s) associated with such a cloud storage service can be configured to perform the processes described in the '294, '466, '888, '058, and '*** Applications in a manner similar to that described in, e.g., the '294 Application. But as noted above, the link between device 110 and such a server would not necessarily be secure; however, as described herein, the processes described can first be run on the content locally prior to transferring the data to the cloud, or an intermediate endpoint. There could be many intermediate “endpoints” before ultimately making it to, for example, the cloud. The single-client to cloud is just one topology. For example, there could be a network of nodes all communicating with each other each using the systems and methods described to secure their data before transmission. Then the fragments can be stored in a dispersed manner on the cloud service. Thus, even if the data were to be intercepted in transit, it would be useless.

In certain embodiments, the application can be configured such that it automatically performs the processes described when the user attempts to store or retrieve data from a cloud storage service. Moreover, the application can be configured such that a document or file at rest, i.e., no interaction with the document or file for a certain period of time, is detected and the processes described are then automatically run to protect the document. When the user then reengages with the document or file, the appropriate processes can be run to allow access to the document or file.

In certain embodiments, the processes described can be performed locally on, e.g., a file, and then performed again as the file is being transferred to, e.g., the cloud and/or intermediate device.

In certain embodiments, sharing and collaboration of documents stored using the processes described can be enabled using the authentication and credential management processes described, e.g., in the '888 Application. Thus, certain individuals can be granted access, which would then be managed using the secure keys generated, e.g., based in the credentials assigned to those individuals.

Another important benefit inures from the processes described when local storage is an unsecure storage device such as a USB drive. In such a case, storing data to the device using the processes described can ensure that even if the data is accessed by the wrong individual or entity, it cannot be used. It should be noted that in certain embodiments, the local application configured to perform the processes described at the local level can reside on such a local storage device, e.g., a USB storage device.

In certain embodiments, the local application can also be configured to provide protection of email attachments. Sending attachments via email is dangerous as attached documents can be intercepted and read by any hacker with enough knowledge. The processes described herein can be implemented with respect to such attachments in such a way as to protect them from being read by anyone other than the intended recipient. Generally, the local application does not interface with email traffic or encrypt the body of the email itself. Rather, a sender of an attachment with the local application can run the processes described on the document they intended to attach (thereby sending it to a public cloud server). The application can then generate an access link to that document. The access link can then be emailed to a recipient instead of the actual document. The recipient can then click on the access link they received to download and decrypt the original document. This of course can require that the recipient also have such a local application to allow the recipient device to retrieve the attachment according the processes described.

In other embodiments, a local application such as described above can also allow for a controlled sequenced “viewing” or “playback” of digital media (documents, books, audio, video, etc.) frames or sections. In such embodiments, an authorized and authenticated subscriber, or user of a device 110 as illustrated in FIGS. 1-4, is only able to retrieve and view separate sequential frames or sections that have been transmitted to them as the media is being displayed (or played). Additionally, after the subscriber proceeds to the next frame or section, the previous played frames or sections are either auto re-stored using the processes described or permanently deleted. Therefore, at any one instance, only a minimal amount of digital media is decrypted and assembled for subscriber consumption thereby minimizing piracy or unauthorized consumption. This can optionally be extended to also limit the number of sequential frames or sections that are authorized for further transmission from the transmitting source to the authenticated and authorized subscriber through a consumption feedback mechanism back the transmission source. The value is for more safely distributing digital media of all types, from consumer to top secret data.

Thus, prior to transmission, such digital media can be broken-down into self-contained sections or frames, and then the processes described of fragmenting/encrypting/dispersing each of those sections or frames is applied prior to transmission to an edge device 110 as illustrated in FIGS. 1-4 and described, for example, in the '*** Application. Upon retrieval, each section or frame can be transmitted at a time in a sequential technique to recompose the underlying fragments making up that section or frame.

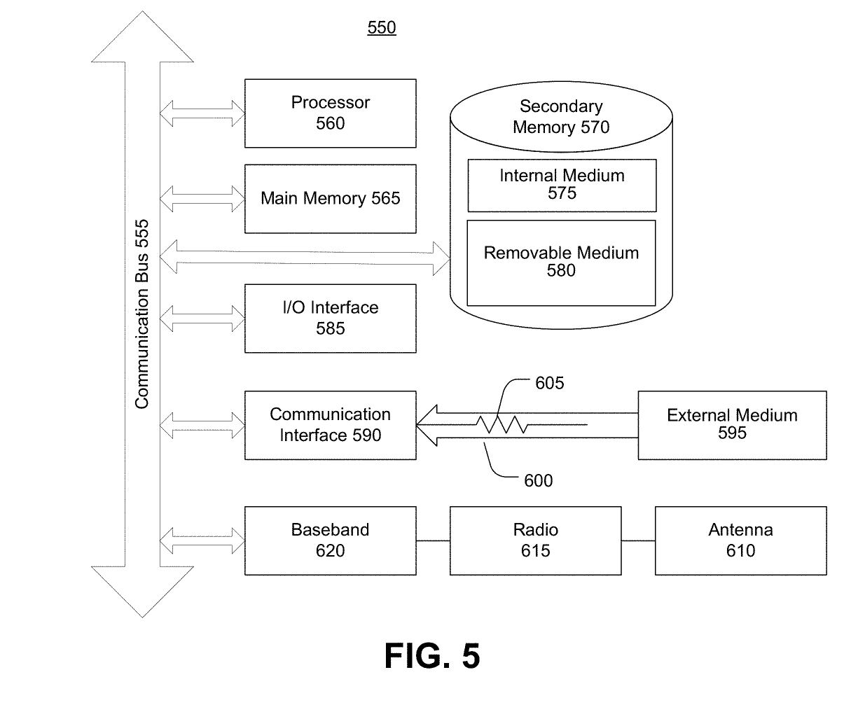

As is noted therein, FIG. 4 of the '888 Application, reproduced herein as FIG. 5, is a block diagram illustrating wired or wireless system 550 according to various embodiments that can be used to implement the client device 110 as illustrated in FIGS. 1-4. Accordingly, this system 550 will not be described here in detail.

### 1. Key Exchange Methodologies

When a new device (such as an IoT device) is added to a network, there needs to be a way to authenticate that device. Various aspects of the present disclosure provide methods for integrating any number of key exchange methodologies, including the built-in key exchange process of the device, to facilitate this operation. This capability enables authenticated communications between two devices, for example, in the case of data streaming between those devices. Once communication is established between the two devices, the key exchange methodology and frequency of exchange may be dynamically varied based on performance requirements and in response to any number of conditions, for example, but not limited to, data security threat levels. An encryption engine may dynamically interoperate and layer with other key exchange solutions including private/public exchange, for example, but not limited to the Diffie-Hellman protocol used in TLS, between devices. Higher levels of security may be achieved by utilizing the most secure keys and maximizing the rate of key rotation for a given set of data.

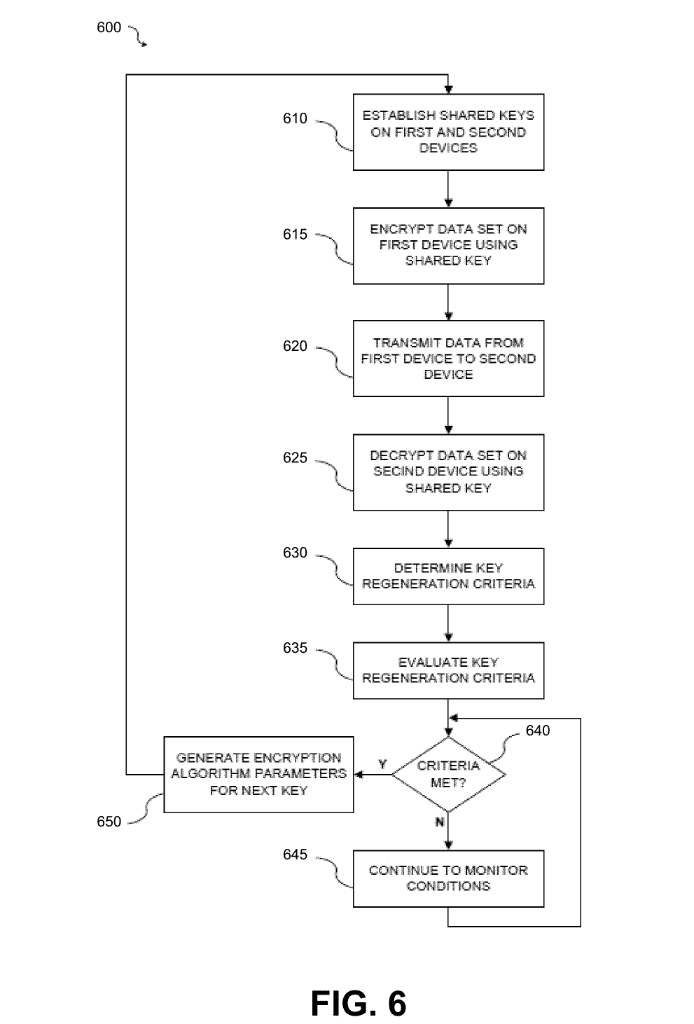

FIG. 6 is a flowchart illustrating a method 600 for exchanging keys in accordance with various aspects of the present disclosure. Referring to FIG. 6, at block 610, based on the current encryption algorithm parameters and seed, each device, for example, a first device and a second device, may establish a shared key. One of ordinary skill in the art will appreciate that more than two devices may be utilized without departing from the scope of the present disclosure.

At block 615 a dataset on the first device may be encrypted using the shared key and at block 620 the first device may transmit the encrypted data to the second device. At block 625 the second device may decrypt the dataset using the shared key. At block 630 key regeneration criteria that indicate whether the keys should be regenerated may be determined. At block 635, the key regeneration criteria may be evaluated for each data set. At block 640, it may be determined whether the key regeneration criteria are met. In response to determining that the key regeneration criteria are not met (640-N), at block 645 conditions that indicate when keys should be regenerated may be monitored until the key regeneration criteria are met at block 640. In response to determining that the key regeneration criteria are met (640-Y), at block 650 new encryption algorithm parameters for the next key may be generated and the method may continue at block 610. The key regeneration criteria may identify possible encryption algorithms and specific parameters for the encryption algorithms.

### 2.Encrypted Data Transmission

In accordance with various aspects of the present disclosure, encrypted data may be transmitted with unique encryptions through multiple simultaneous client destinations including, but not limited to, streams, filesystems, and/or clouds. Encrypted data may be directed to any number of destinations such as a stream format decrypted to a video player, or as a set of fragments stored securely on a filesystem or cloud. The item to be encrypted can be in any number of data formats including, but not limited to, files (e.g., Word documents, photo files, virtual machine files, etc.), key-value pairs (e.g., simple strings such as JSON or other formats suitable to store form data, application settings and preferences), and streams (e.g., video or data feeds).

In accordance with various aspects of the present disclosure, each object may be disassembled into smaller fragments enabling a reduction in the total transmission time, T, for each object, in some cases enabling transmission times up to 8-15 times faster than conventionally available. Fragments of an object may be encrypted only once while increasing security by utilizing unique keys for each client. This approach may provide a performance advantage even while sending encrypted data to multiple client destinations. Each destination may have a unique decryption key to access the data. Multiple secure output streams to multiple destinations may be created while minimizing hardware resource demands. Fragmenting, encrypting, and transmitting data between computing devices can achieve low latency and full data encryption. In accordance with various aspects of the present disclosure, the approach may be scaled to support multiple clients maintaining a unique shared secret key between each client and encrypting the manifest differently for each intended client.

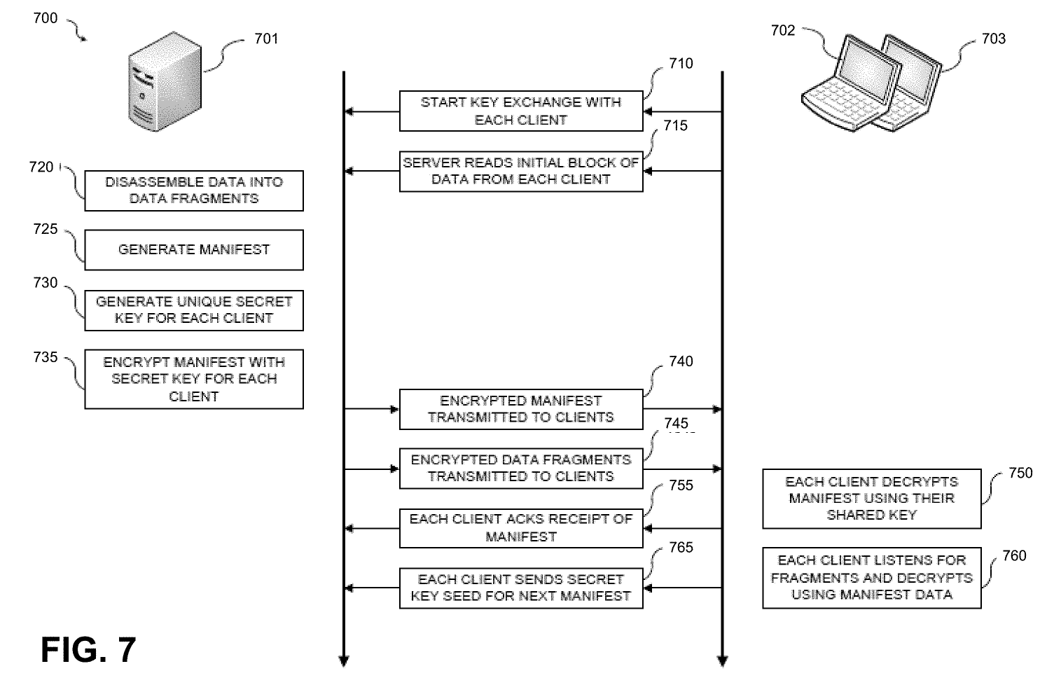

FIG. 7 is a sequence diagram illustrating an encrypted data transmission sequence 700 in accordance with various aspects of the present disclosure. Referring to FIG. 7, at block 710 client software running on each client 702, 703 communicates with the server 701 and starts a key exchange process. At block 715, the server 701 reads a block of data, for example, one frame of a video stream, a sample of audio, etc., from a source which could be a file or data sensors including, but not limited to cameras, video, and/or audio sensors. At block 720, the server 701 disassembles the data creating data fragments. At block 725, the server generates a manifest for each of the clients 702, 703 which contains, among other data, unique encryption keys for each of the data fragments. At block 730, the server 701 uses the key exchange information from each client 702, 703, to create a unique shared key for each client 702, 703. At block 735, the server 701 encrypts the manifests using the unique shared key for each client 702, 703.

At block 740, the server 701 transmits the encrypted manifests to each of the clients 702, 703. One of ordinary skill in the art will appreciate that different data may be transmitted to each client 702, 703 and therefore a different manifest may be generated and transmitted by the server 701 to each of the clients 702, 703. The server 701 encrypts the data fragments and at block 745 transmits the encrypted data fragments to the intended clients 702, 703. At block 750, the client software running on the clients 702, 703 awaits receipt of the manifest and decrypts the manifest using the unique shared key. At block 755, each client 702, 703 acknowledges receipt of the manifest to the server 701. At block 760 each client 702, 703 listens for encrypted data fragments and decrypts each data fragment using data contained within the manifest. At block 765, each client 702, 703 sends a shared key seed for the next manifest to the server 701.

The sequence of FIG. 7 may be repeated for each block of data read from a client. The data fragments may be received by the clients in any order and will be reassembled and processed in the correct order. The server may repeat the sequence for the next block of data all beginning at block 720. For each block of data, the client will await the receipt of the corresponding manifest. If the server does not receive a manifest acknowledgment from the client, the server will withhold the next block of data until an acknowledgment is received or until a timeout interval has expired. If a client receives an incomplete or inaccurate manifest the server may be notified to resend the current manifest encrypted with a new shared key. If a client receives incomplete or inaccurate data fragments, the server may be notified to resend the current block of data.

### 3. Data Encryption Speed

In accordance with various aspects of the present disclosure, a preprocessor may pre-slice or break up a large file into smaller pieces prior to the fragmentation and encryption processes. A companion post processor may recombine the file subsequent to decryption and defragmentation. By disassembling data objects into smaller fragments and encrypting those individual fragments across multiple processor threads a speed advantage (e.g. 5×-15×) may be gained without reducing the key size or otherwise compromising the security level. “Slicing,” i.e., breaking up a large file into smaller pieces prior to fragmentation and encryption and then recombining them after defragmentation and decryption, can increase performance and permit processing of very large data objects on devices that have limited memory.

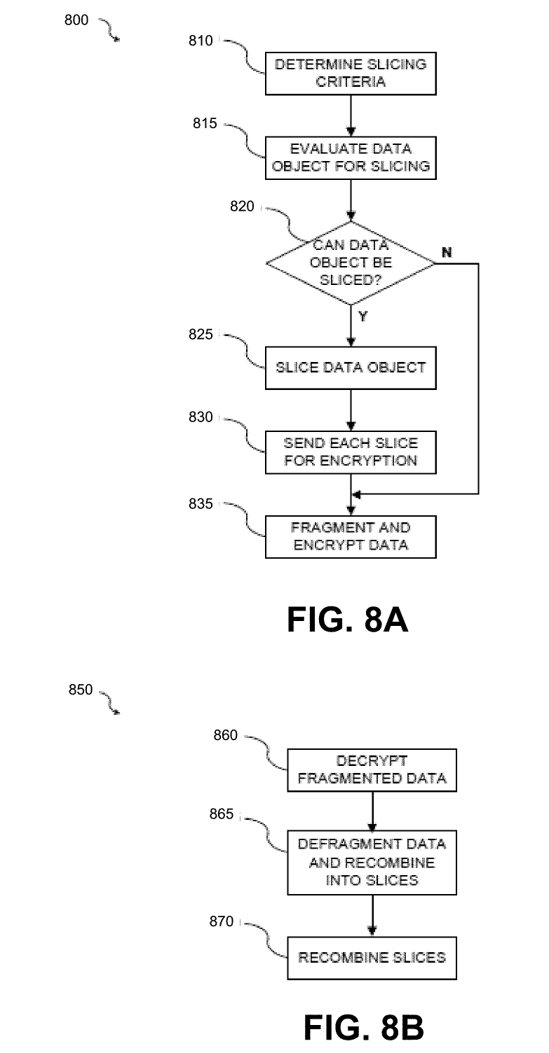

FIG. 8A is a flowchart illustrating a method 800 for pre-slicing data to increase encryption speed in accordance with various aspects of the present disclosure. Referring to FIG. 8A, at block 810 data slicing criteria may be determined. At block 815, a data object may be evaluated for slicing based on the determined slicing criteria. At block 820, it may be determined whether the data object can be sliced. In response to determining that the data object can be sliced (820-Y), at block 825, the server may break up or “slice” the data object into smaller pieces of data, and at block 830 each data slice may be sent for encryption. At block 835, the server may disassemble each data slice into data fragments and the data fragments may be encrypted. The data may be disassociated and dispersed for storage in one or more storage locations.

FIG. 8B is a flowchart illustrating a method 850 for recombining a data file in accordance with various aspects of the present disclosure. Referring to FIG. 8B, at block 860, encrypted data fragments may be decrypted. At block 865 the decrypted data fragments may be defragmented and recombined into data slices. At block 870, the slices may be recombined into the data object.

### 4.Encryption Key Management

In accordance with various aspects of the present disclosure, the system may distribute keys to key stores residing within a local operating system. In some cases, for example, in the case of a network outage, a device may not be able to access the remote user and key or similar license service. The remote service may be used to verify the user's license credentials such as username and password at the time of login. In such cases where the remote service is unavailable the client software may validate the user credentials locally by accessing the encrypted key store on the local device. The system may populate and manage this local key store as a backup for resiliency against network outages.

The system may deliver key management (KM) software including all of the expected state of the art capabilities. However, when communication to the key management server is lost not because the key management server is down, but because the remote device is not able to connect to it as result of a network outage or some other connection problem.

Given a scenario where the system client software is running on a device such as a laptop or other network enabled computing device and the connection to the key management server is lost, the client software continues to encrypt/decrypt data on that device. The client software will generate a local key store on the operating device as a backup in case the remote key management server connection is lost. The local key store can be configured to maintain the specific keys or key encryption keys needed by the user including any additional user credentials required. The key store itself may be encrypted and only available to the authenticated user.

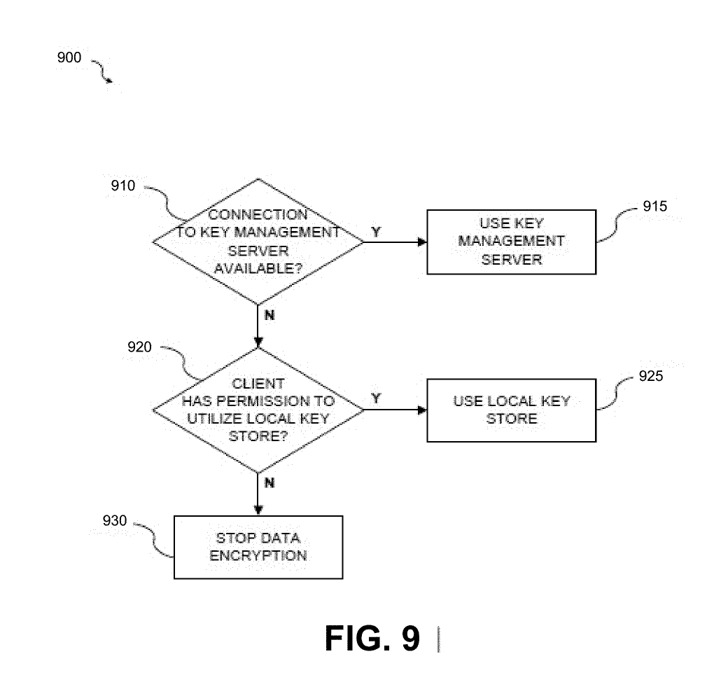

FIG. 9 is a flowchart illustrating a method 900 for managing encryption keys in accordance with various aspects of the present disclosure. Referring to FIG. 9, at block 910, it may be determined whether a connection to a key management server is available. In response to determining that the connection to the key management server is available (910-Y), at block 915 a client may communicate with the key management server to access encryption keys.

In response to determining that the connection to the key management server is not available (910-N), at block 920 it may be determined whether the client has permission to utilize a local key store. In response to determining that the client has permission to utilize the local key store (920-Y), the client may access encryption keys from the local key store. In response to determining that the client does not have permission to utilize the local key store (920-N), at block 930 data encryption may be stopped.

Compound Security Keys

In accordance with various aspects of the present disclosure, user and key technology may support compound keys using AND/OR Boolean logic. The system extends the concept of compound keys by introducing a dynamic expression to control the key's access requirements. A compound key can be defined using any number of sub keys. In order for the compound key to be valid, the integral sub keys should be all present and correct (Boolean AND), or at least one of the sub keys should be present and correct (Boolean OR). There may be any combination of Boolean constructs used to define a valid key.

In accordance with various aspects of the present disclosure, a dynamic expression may be used to control a key's access requirements. Keys may have any combination of Boolean expressions to limit or control a key's capabilities. For example, a key's access expression may be described as (Alice AND (Bob OR Carl)) and only allow Alice to unlock a file if done in concert with either Bob or Carl. Compound keys may also incorporate an unlimited variety of other conditionals, not just user names, including geo location, clock time, and hash checksums. For example, (Alice AND (Bob OR Carl) AND ACCESSTIME IS EQUAL BUSINESSHOURS) may add a restriction to business hours only. Furthermore, key access expressions may incorporate dynamic conditionals that may change based on external conditions for example, but not limited to whether security threat levels are high. For example, (Alice AND (Bob OR Carl) AND SECURITYLEVEL IS EQUAL (NORMAL OR LOW)) may only allow access when security conditions are at normal or low levels. These expressions allow highly responsive access controls to automatically keep data secure even as conditions change fast as during a hacker attack. One of ordinary skill in the art will appreciate that other combinations may be used without departing from the scope of the present disclosure.

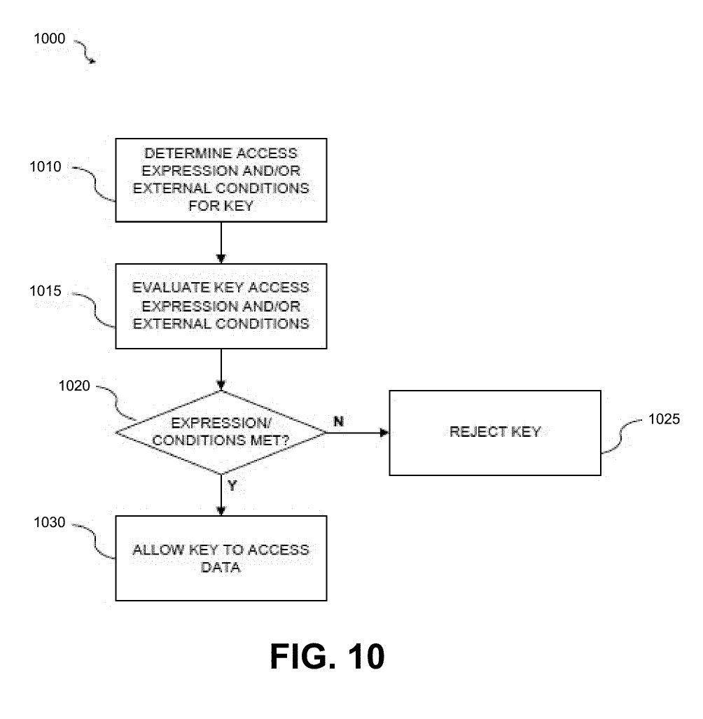

FIG. 10 is a flowchart illustrating a method 1000 for evaluating a compound key in accordance with various aspects of the present disclosure. Referring to FIG. 10, at block 1010, for each attempted data access, an access expression for a security key may be determined. For example, the access expression may include any combination of Boolean expressions and/or external conditions. At block 1015, the access expression for the security key, including any required external conditions, may be evaluated. At block 1020, it may be determined whether the access expression and/or external conditions are satisfied.

In response to determining that the access expression and/or external conditions are not met (1020-N), at block 1025 the security key may be rejected, and data access may be denied. In response to determining that the access expression and/or external are met (1020-Y), at block 1030 the access key may be accepted, and data access permitted.

### 5. Data Access Restriction

In accordance with various aspects of the present disclosure, encrypted data may include any number of access restrictions including but not limited to user roles, compound keys, geo location, time of access, length of time of access, order of access in relation to other keys. An otherwise valid user session may be restricted from accessing data when certain conditions are not satisfied. These conditions can be arbitrarily defined and assigned to any data item. For example, if a particular data item should only be accessed from users within a certain geographical region and at a certain time of day, the system will not allow the user to access this data item if those conditions are not met. The system may provide certain “canned” restriction types for convenience, but additional restrictions may be added.

The system applies the access restrictions to the data element level. This approach can maximize flexibility where each data item, for example a social security number, could have its own set of access restrictions that could be different from another social security number. In addition, the access restrictions can be arbitrary and may be expressed as Boolean expressions and stored as metadata. All access restrictions are fragmented, encrypted, disassociated, and dispersed to prevent hackers from discovering or altering the restrictions.

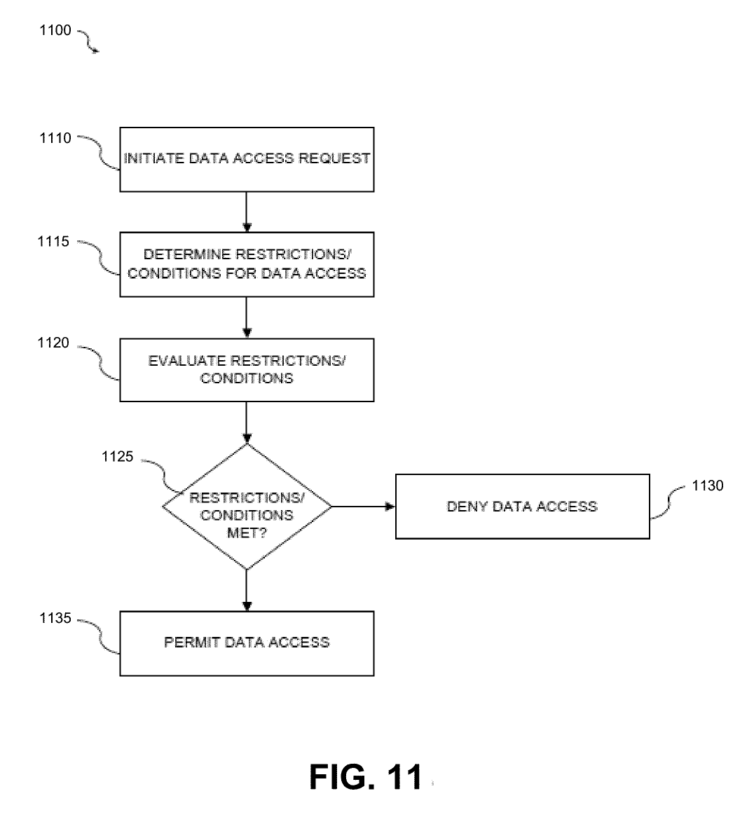

FIG. 11 is a flowchart illustrating a method 1100 for restricting data access in accordance with various aspects of the present disclosure. Referring to FIG. 11, at block 1110, a request to access data may be initiated. At block 1115, access restrictions and/or conditions for accessing the data may be determined. Access restrictions/conditions may include, but are not limited to user roles, compound keys, geo location, time of access, length of time of access, order of access in relation to other keys. At block 1120, the access restrictions and/or conditions may be evaluated. At block 1125, it may be determined whether the access restrictions/conditions have been met.

In response to determining that the access restrictions/conditions have not been met (1125-N), at block 1130 access to the data may be denied. In response to determining that the access restrictions/conditions have been met (1125-Y), at block 1135 access to the data may be permitted.

### 6. Hacking

In accordance with various aspects of the present disclosure, rapid detection technology supports “honey pot keys” which when used will trigger specified action for example, but not limited to, alerts, key rotation, etc. Honey Pot keys are exposed keys left for hackers and/or illicit software to find.

Valid access keys and credentials are necessary for a user to properly access data protected by the system. The Rapid Detection algorithm triggers an exception event if an incorrect key is used to access any data. The keys may include “honey pot” keys which could be left for hackers to find and attempt to use as well as “duress keys” which are entered by legitimate users under force. Exception events caused by incorrect or false keys can be used to automatically rotate keys, shut out users, and alert security personnel.

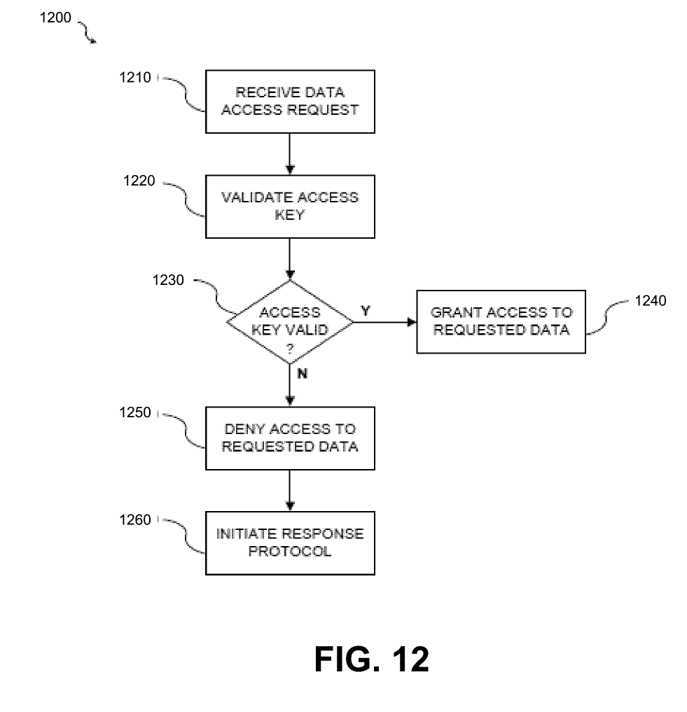

FIG. 12 is a flowchart illustrating a method 1200 for detecting and responding to hacking attacks in accordance with various aspects of the present disclosure. Referring to FIG. 12, at block 1210, a data access request may be initiated and received by the system. At block 1220, an access key provided with the data access request may be validated. For example, a rapid detection algorithm may be applied to the access key. At block 1230, it may be determined whether the access key is valid for the requested data. In response to determining that the access key is valid (1230-Y), at block 1240, access to the requested data may be granted.

In response to determining that the access key is not valid (1230-N), at block 1250, access to the requested data may be denied. At block 1260, a response protocol may be initiated. For example, the response protocol may cause the user that initiated the data access request to be logged out completely, may deny access only to the requested data item, or may allow access to only a limited set of data. Alternatively, or additionally, the protocol may notify system administrators of the access attempt with an invalid access key and/or rotate encryption keys and/or shutdown the system.

### 7.Ransomware

In accordance with various aspects of the present disclosure, anti-ransom encryption protection may include “canary files” used by the system to determine if a system has been unexpectedly altered before data is operated on, for example to create a backup archive. The system makes the assumption that a ransomware attack will happen and accordingly makes regular backups for recovery. However, damaged files infected by a ransomware virus should not be backed up. For an enterprise using the system to archive users' hard drives on a network, “canary files,” which are small files scattered throughout the user's hard drive, are used. If any of these canary files are missing or altered, it is an indication that the drive has been compromised. Before performing a backup, the system will check for the canary files, thereby preventing a backup of an infected drive (and potential overwrite of the last good backup). To recover from an attack, the last good archive can be decrypted to replace the contents of the infected hard drive.

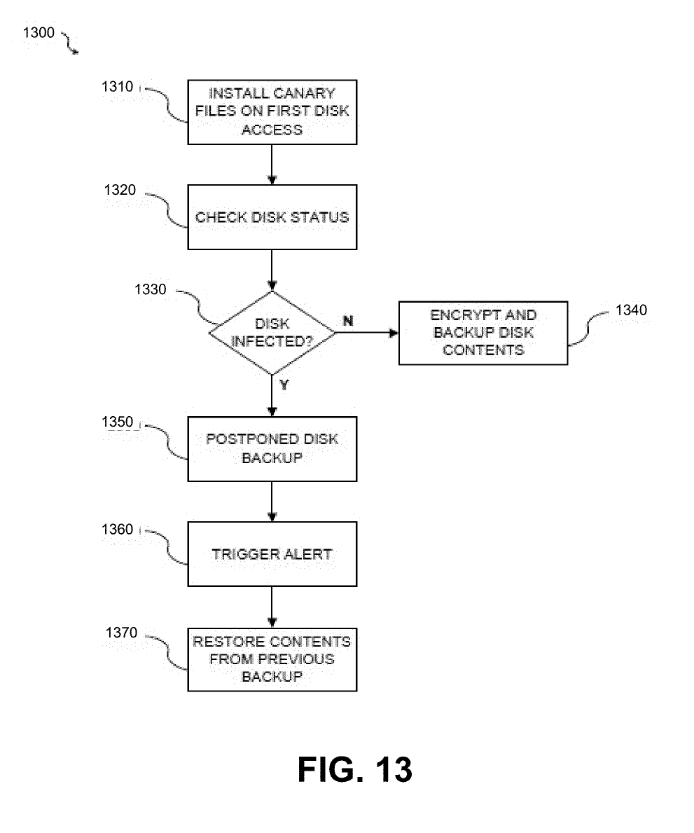

FIG. 13 is a flowchart illustrating a method 1300 for detecting and responding to ransomware attacks in accordance with various aspects of the present disclosure. Referring to FIG. 13, at block 1310, upon a first access of a disk drive by the system, the system may install one or more canary files. For example, small known files may be scattered throughout the disk drive. At block 1320, a status check of the disk drive may be performed by verifying whether the canary files are valid. For example, the installed canary files may be compared with the expected number and content of the canary files. A missing or altered canary file may be an indication that the disk drive has been compromised.

At block 1330, it may be determined whether the disk drive has been infected with ransomware. For example, the system may determine if any of the canary files are missing or altered. In response to determining that the disk drive has not been infected (1330-N), at block 1340, the disk drive contents may be encrypted and backed up to another disk drive.

In response to determining that the disk drive has been infected (1330-Y), at block 1350, backup of the disk drive may be postponed. Postponing disk drive backup prevents overriding a last known good copy of the disk drive contents. At block 1360, an alert may be triggered to notify administrators of the infected disk drive. At block 1370, the disk drive contents may be restored from a previously backed up version.

### 8. Searching Encrypted Data

In accordance with various aspects of the present disclosure, Accelerated Access Records (AAR) for pre-indexing data are stored separately from the data to be indexed and may be mined by 3rd party software to provide analytics and reporting. AARs are optimized search records that can be integrated into third party search tools providing advanced analytics and reporting. These search records may be stored by the system separately on another server for security purposes. This second server, also running the system, can have a separate authentication layer allowing 3rd party access and/or 3rd party search tools.

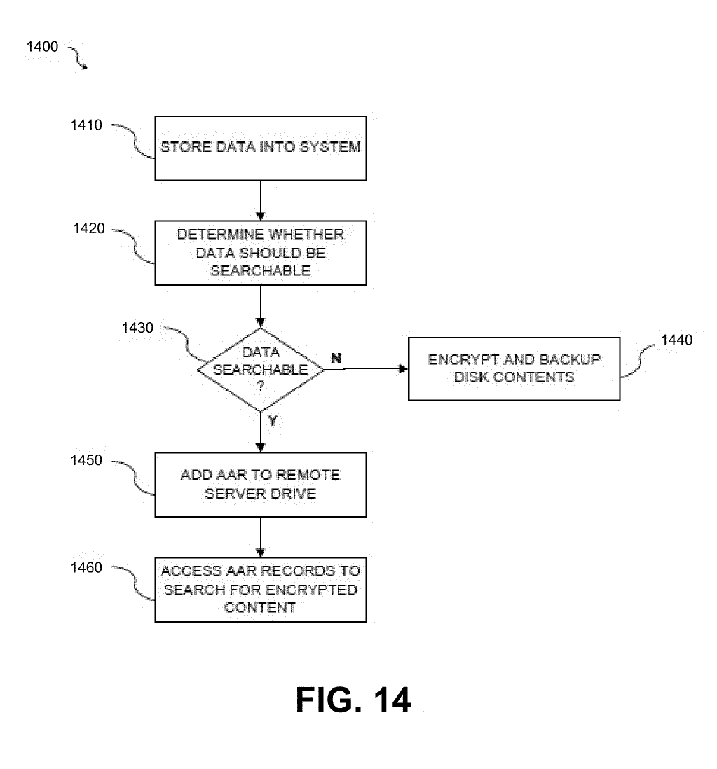

FIG. 14 is a flowchart illustrating a method 1400 for enabling searching on encrypted data in accordance with various aspects of the present disclosure. Referring to FIG. 14, at block 1410, data is stored on a disk in the system. At block 1420, the data may be checked to determine whether the data should be searchable. In response to determining that the data should not be searchable (1430-N), at block 1440 the system will not create accelerated access records (AARs).

In response to determining that the data should be searchable (1430-Y), at block 1450 the system may add accelerated access records (AARs) to a remote server drive on the system. At block 1460, when the data is searched, the AARs may be accessed to search for encrypted content.

### 9. Data Encryption

In accordance with various aspects of the present disclosure, all data encrypted by the system may be stored and organized into a user-definable set of locations called a Virtual Cryptological Container (VCC) (e.g., a data repository). Encrypted data may be dispersed across multiple data stores in the VCC. These VCCs may span from a single device, for example, but not limited to a USB stick, up to multiple data centers, and may have dynamically definable locations. Unauthorized relocation of these VCCs to other devices is detectable by the system and could trigger any number of actions including disabling access and key rotation.

The VCC may be configured such that it exists entirely on a single drive or on multiple drives across multiple data centers and formats. The flexibility of this approach stems from the ability of the system to virtualize storage such that applications do not care how or where the encrypted data is being stored. Applications only interact with the system for sending data to encrypt and for retrieving that data to decrypt. The system may manage one or more storage locations. Some benefits of this approach may include:

A VCC may exist wholly within a single hard drive making it easy to transport safely to another hard drive. For example, a VCC can be placed on a USB stick and remain fully encrypted until such time the system is used to access that VCC.

A VCC may have markers that restrict its use under certain circumstances. For example, a VCC can be encoded to work only when located on a specific drive or hardware MAC Address or some other signature ID. The VCC can be restricted to work only when accessed from a specific geo location or a certain time of day or date. The system will not be able to encrypt or decrypt data unless these VCC conditions are met.

A VCC eliminates an application needing to know what the underlying storage media is and what the specific API is for that media. For example, there are many cloud data stores such as Amazon S3 and MS Azure that all have unique APIs that must be integrated into the application before those services can be utilized. The system may provide a single API to all those storage options including direct on-device storage.

Replication and backup options are facilitated through the use of a VCC and a variety of options may exist. For example, if a VCC is wholly stored on a single device, such as a tablet computer, the VCC may be periodically duplicated and stored off-device as backup. If a VCC spans multiple storage locations, the system may be configured to replicate each storage request in real time to a parallel VCC. The underlying data stores (e.g., Amazon S3 Cloud) may also have their own backup process enabled which will work seamlessly with the system.

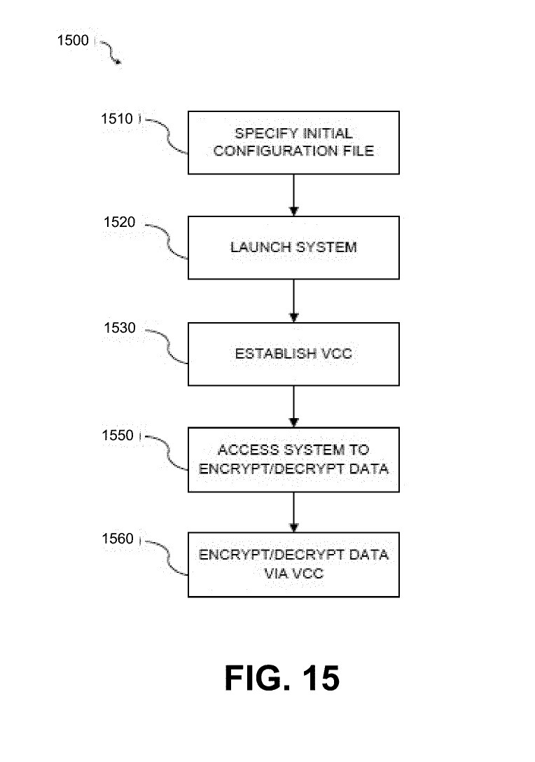

FIG. 15 is a flowchart illustrating a method 1500 for utilizing a virtual cryptological container for storing encrypted data in accordance with various aspects of the present disclosure. Referring to FIG. 15, at block 1510, a setup configuration file including a pathname to each of the available storage locations may be specified. The storage locations may be on a hard disk drive on the device, may mounted drives in a LAN or across a WAN to remote cloud service endpoints, or may be a combination thereof The setup configuration file may also specify other system options.

At block 1520, the system may be launched, and at block 1540 a VCC may be established. For example, the system may read the setup configuration file and establish the VCC for subsequent access. At block 1550, the system may be accessed to encrypt or decrypt data. For example, an application that needs to encrypt or decrypt data may make an API call to the system. At block 1560, the data may be encrypted or decrypted via a VCC as requested by the application. For example, the system may execute the application's request by encrypting and storing the data in the VCC or retrieving and decrypting data stored in the VCC.

In accordance with various aspects of the present disclosure, the system may include a security engine having an ability to adapt to regulatory restrictions. The system may be configured with non-export restricted AES-128 or lower ciphers. Alternatively, the system may be configured to utilize FIPS 140-2 libraries or an external encryption hardware appliance. The system is not tied to any encryption cipher and therefore adapts and grows with user needs and requirements. For example, for users in countries where strong crypto libraries cannot be exported to the system may be configured with libraries permitted under US export law.

Further, the system may operate as a centralized server or encryption appliance as well as having an ability to run on an endpoint device to protect data upon capture. In accordance with the present disclosure, the data fragments may have tamper detection upon being received to eliminate possibility of hacker changing data in transit. The system authenticates individual fragments as they are being received. Several methods may be used to perform this authentication including but not limited to GCM based AES-256 encryption. Fragments that fail this authentication are identified as tampered and will be rejected. Depending on configuration, FHOOSH will respond in a variety of ways such as key rotation, connection termination or by resending the fragment.

### 10. Client-Implemented Embodiment

In accordance with the present disclosure, the process described in the '294, '466, '888, '058, and '*** Applications and described in the present disclosure can be implemented at the edge, i.e., on client endpoint 110 as illustrated in FIGS. 1-4. For example, an application can be loaded to device 110, such that data can be saved to and retrieved from different portions of local or locally connected storage device 140 or such that the data can be saved and stored to a plurality of storage devices 140-170. For example, as described in the '294, '058, and/or '*** Application. Thus, if the user of device 110 creates a document, video, picture, etc., the user can invoke to the application to store the document or file. Similarly, the application can perform the diffractive retrieval of the data or file as described in '466 Application, enforce the management of credentials and encryption keys as described in '888 Application, and transmit encrypted data to remote devices as described in the '*** Application.

In various embodiments, access to the system can be provided by software running on a computing device such as a desktop or laptop, or through an application running on a portable electronic device such as a tablet or smartphone. In some embodiments, the application may be installed on the computing device that provides access to the system. In some embodiments, the application may access the system through an application programming interface (API) and/or software development kit (SDK). Thus, in some embodiments, the system can be accessible over a web-based API, where all of the user's information is securely stored, e.g., in a secure server facility in a cloud-based network. In various embodiments, the systems and methods described in the present application may be integrated into software running on a computing device, for example, integrated into a higher-level operating system configured via a software development kit (SDK) to perform the processes and methods described herein.

As described above, the application can be presented as a button in a toolbar, pop-up overlay, or drop down menu such that when the user is in a document or file on their device 110 as illustrated in FIGS. 1-4, they can simply press the button, icon, etc., in the associated application or in a web browser and the document can be stored accordingly. The document or file can then be shown on device 110 in a manner that indicates that it has been stored using the processes describe above. When the user accesses the document or file again, the retrieval process described above can automatically take place. In certain embodiments, the user can also select various dispersion preferences as to where all, or some, of the fragments are stored. For example, users may select virtual cryptological containers that provide dispersion criteria for storing data fragments in different storage locations as described above in connection to FIG. 15 and in the '058 Application.

In other embodiments, a right click on a file can be used to select the storage processes described. For example, the application implemented through an SDK may integrated the system into the application (e.g., a file management system), such that the methods and processes described herein may be executed in the background. In still other embodiments, the application can automatically determine that a file should be stored using such processes. In still other embodiments, the default for all files, certain files, certain types of files, etc., can be set to use such processes.

As mentioned above, the systems and methods described herein may be implemented via a SDK that comprises various API(s) and/or command-line interfaces (CLI) to facilitate integration of the systems described herein into third party applications and operating systems. By utilizing these functionalities, users need not provide commands to the systems described herein via a direct user interface, but may advantageously access the functionality through other applications and software packages external to the systems described herein.

For example, third parties may utilize API(s) to programmatically access the systems and methods described herein to integrate disparate systems developed by third parties. For example, a third-party application may be programmatically mapped via API and CLI to the systems described herein so to integrate the methods and advantages described herein into third-party applications. That is, a third-party application can be loaded to a user device (e.g., endpoint device 110), such that data can be saved to and retrieved for use by the third-party application from different portions of local or locally connected storage device as described herein and in the '294, '466, '888, '058, and '*** Applications or such that data can be saved and stored to a plurality of storage devices as described herein and in the '294, '466, '888, '058, and '*** Applications. Thus, if the user of device creates a document, video, picture, etc., using the third-party application, the user can invoke the API(s) to store the document or file. This can involve doing all the steps described herein to store the fragments in a dispersed manner to different locations in storage device(s) as described above, for example, in the '294 and/or '058 Applications. Similarly, the third-party application can perform the diffractive retrieval of the data or file as described in the '466 Application, and can enforce the management of credentials and encryption keys as described in the '88 Application.

As yet another example, the systems and methods described herein may be implemented via one or more CLI(s) to interface with SDKs and/or API(s) of third-party applications, software packages, and/or operating systems. For example, the CLI(s) may be implemented by third parties to integrate the methods and systems described herein into the operating system functioning on the user device (e.g., Windows, macOS, Google Android, iOS, etc.). As an illustrative example, data can be stored to and retrieved through a file manager or file browser of the operating system (e.g., user interface providing drag and drop functionality into folders and files). Upon such storage and/or retrieval, the systems described herein may be used to store the data at different locations of local or locally connected storage device such that data can be saved and stored to a plurality of storage locations. In some embodiments, the file manager may be configured to represent the different storage locations as a single storage location (e.g., folder) within the operating system. The single folder may be representative of a virtual cryptological container, for example, as described in the '058 Application and above in connection to FIG. 15. Thus, if the user of a device creates a document, video, picture, etc., the user can invoke the CLI(s) to store the document or file via the file manager of the operating system integrated with the system via the SDK. This can involve doing all the steps described herein to store the fragments in a dispersed manner to different locations in storage device(s) as described above, for example, in the '294 and/or '058 Applications. Similarly, the third-party application can perform the diffractive retrieval of the data or file as described in the '466 Application, and can enforce the management of credentials and encryption keys as described in the '88 Application.

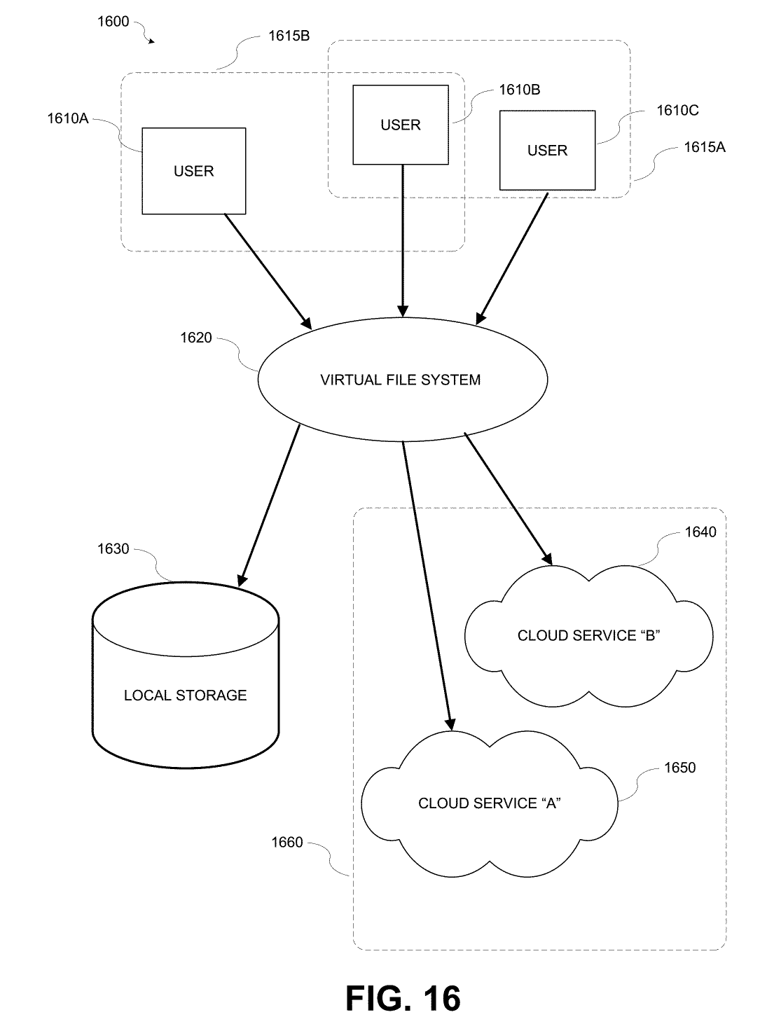

FIG. 16 is a diagram illustrating a system 1600 including a virtual file system 1620 in accordance with various aspects of the present disclosure. The VFS 1620 may be substantially similar to the various VFS described throughout the present application, for example, the VFS 320 of FIG. 4 described in the '058 Application and above in connection to FIG. 15. As illustrated in FIG. 16, the system 1600 may include the VFS 1620, and a plurality of storage devices, for example but not limited to, local storage 1630 (e.g., local or locally connected device 140) and as well as cloud storage provided by cloud service providers or other remote storage locations 1650, 1640, for example but not limited to, Amazon S3 and Azure. The system 1600 may accept inputs from one or more users 1610A-C of the system via applications, user commands, and third-party application programming interfaces (APIs) as described above running on a client endpoint device 110. The VFS 1620 may include an encryption engine in accordance with the description herein and in the '294, '466, '888, '058, and '*** Applications.

The VFS 720 can be programmatically mapped to facilitate integration of disparate systems that ordinarily are not able to communicate with each other via API(s) and/or CLI(s). For example, one third-party system may use the command “save as” and other system may use the command “pseudo cp” to perform the same operation. The VFS may be configured to recognize all interchangeable commands.

In some embodiments, each user 1610A-C may be associated with one or more accounts. Users can be assigned to accounts by, for example, another user (such as an administrator) or a user can self-register as explained below. An administrator may be required to authorize access of users that self-register before access to the system 1620 may be granted. An administrator can also revoke access for any user.

The system 1600 may be configured to perform one or more of the various processes described throughout the present disclosure and for example in the '058 Application. For example, the '058 Application describes example methods for storing data with a VFS and for accessing date with a VFS,

For example, a method for storing data with the VFS system 720 may include receiving a store command for a file to be stored with the VFS 720. For example, a command to save a file may be received from a local computer via an application running thereon. The file may be disassembled into file fragments by the application, for example, by the encryption engine 250 of FIG. 4. Each fragment may be separately encrypted by the encryption engine 250.

File fragments may be mapped to storage locations via virtual cryptological containers (sometimes referred to herein as a “data map”), for example, as described in the '058 Application and above in connection to FIG. 15. For example, the encrypted fragments may be mapped by the encryption engine 250 to storage locations dispersed across multiple locations within a storage medium and/or across multiple storage media. The encryption engine 250 may store mapping information of the encrypted file fragments in the virtual cryptological container. In accordance with various aspects of the present disclosure, the encryption engine may generate, encrypt, and store a data map that includes at least a portion of the information required to retrieve and reconstruct the decomposed data object.

The encrypted file fragments may then be transmitted to the storage locations mapped via the virtual cryptological container. For example, the encryption engine 250 may interface with the VFS 720 to store files remotely in a cloud-based system at a remote server, with portions of the file stored in separate locations with separate encryption. Alternatively, or additionally, portions of the file may be stored in separate locations on local storage (e.g., on-premise). The encrypted file fragments may be stored in the storage locations mapped by the virtual cryptological container.

In some embodiments, a method for accessing data with the VFS may include receiving a command requesting retrieval of a file stored with the VFS. For example, a command to retrieve a file may be received from an application running a client device. The application and/or VFS may determine whether access to the file is authorized. Individual files may not be available to every user of the system in which case the file will not be unlocked. When paired with a remote key server, the VFS may be configured to transparently authenticate the user and retrieve the corresponding key(s) on a per-file and/or per-access basis.

If it is determined that access is not authorized, access to the file is denied. If it is determined that access to the file is authorized, encrypted file fragments may be retrieved from the different storage locations mapped via the virtual cryptological container, for example, from storage locations based on the mapping information contained in the virtual cryptological container. The encrypted file fragments may be received by the application from the different storage locations, for example, from the various mapped storage locations. The file fragments may be decrypted and reassembled into the requested file.

Returning to FIG. 16, a plurality of users can be assigned to one or more groups, for example, groups 1615A and 1615B. For example, FIG. 16 illustrates two example groups 1615A and 1615B comprising users 1610B, 1610C and users 1610A, 1610B, respectively. Groups 1615A and 1615B are illustrative examples, and other arrangements are possible. For example, users may be included in one or more different groups or may be part of a single group. Each group may include any number of users as assigned in the system 1620, to be described below in greater detail. Groups may be collections of users that are granted similar access based on the needs of the users. For example, user 1610C and 1610B may be part of the Marketing Department and be defined as members of a ‘Marketing’ group 1615A.

Each member of the group may inherit permissions and access rights based on the groups to which they are assigned. For example, each group may have certain permissions and access rights that provide access to certain data while restricting access to others. For example, as described in FIG. 11, data access may be restricted or granted based on conditions. Furthermore, devices of users in certain groups may comprise certain keys installed therein for accessing and data.

Similarly, a plurality of storage devices and/or storage locations (e.g., local storage 1630, cloud storage 1650, and/or cloud storage 1640) may be grouped into virtual cryptological containers. FIG. 16 illustrates one example where cloud storage 1650, 1640 are grouped into a virtual cryptological container 1660. For example, the system 1620 fragments, disassociates, separately encrypts and then distributes data to the one or more locations where the data may be stored, either locally or in the cloud, for example, into cloud storage 1650 and 1640. The virtual cryptological containers may group a plurality of storage devices and/or a plurality of locations within a single storage location. Thus, the system may associate a single virtual cryptological container with one or more locations in which data fragments and/or manifest data can be stored. In some embodiment, virtual cryptological containers associated with each user may be set up or assigned by the administrator, as described below.

Multiple virtual cryptological containers can be defined for any given user (or group) to allow distribution of secure data in a number of storage locations. In certain embodiments, a user may select at least one assigned virtual cryptological container to begin protecting data via the application or accessing previously secured and stored data. In some embodiments, a virtual cryptological container may be represented, displayed, or otherwise presented to a user of the system as a folder in a file manager system.

The systems described herein allows a user to select a data file to be securely transmitted and stored in a chosen virtual cryptological container for distribution to a storage location of choice, leaving the original file unsecured in the source directory. For example, a user who is a member of the Marketing Team group can access a given virtual cryptological container to select, secure and transmit a large graphics file to the Marketing Team's cloud folder or to the team's storage location. A virtual cryptological container may be mapped within the application on the endpoint device, so the user can select and secure data either locally or in a remote location. Similarly, the systems herein may allow a user to select a data file to be retrieved from a virtual cryptological container.

Groups may be assigned authorization to access one or more virtual cryptological containers, with varying levels of permissions. These permissions may include, but are not limited to, whether a member of the group can perform the ‘secure,’ unsecure,' ‘secure live,’ and ‘Delete’ functions on the virtual cryptological container. In certain embodiments, a standard user may not have authorization to a virtual cryptological container, and thus would not be granted access thereto.

In various embodiments, an administrator may create one or more groups, assign one or more users to the groups, and assign virtual cryptological containers to the various groups. The virtual cryptological containers may be mapped to one or more storage locations by the administrator, before or after assigning the groups. Once the set of groups, users and virtual cryptological containers have been created and assigned, as new users attempt to access the system, the administrator may register new users and assign the user to one or more existing groups, or create new group(s), and/or virtual cryptological containers for the new user. In some scenarios, new users may self-register and the administrator may need only approve their login and assign them to and/or create new groups.

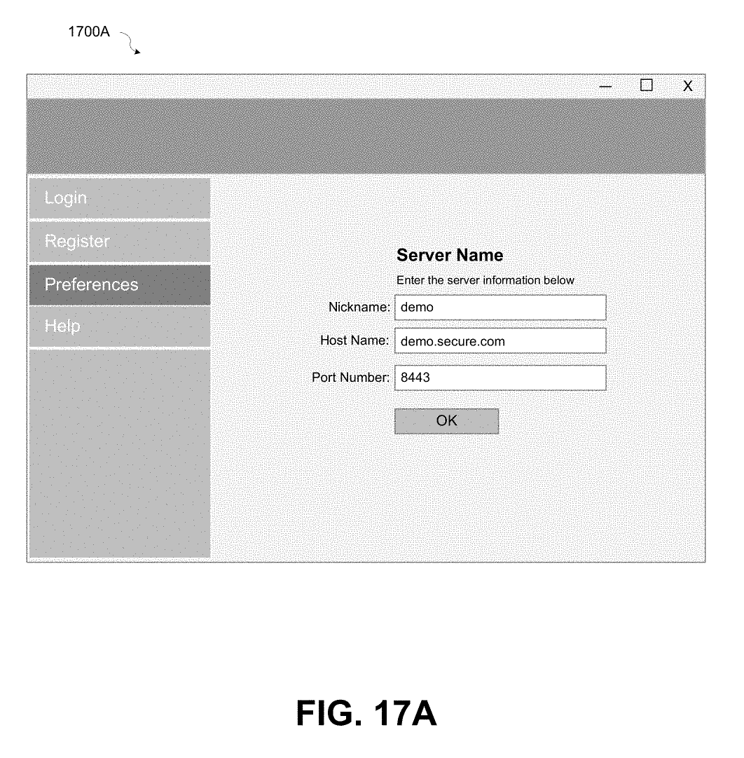

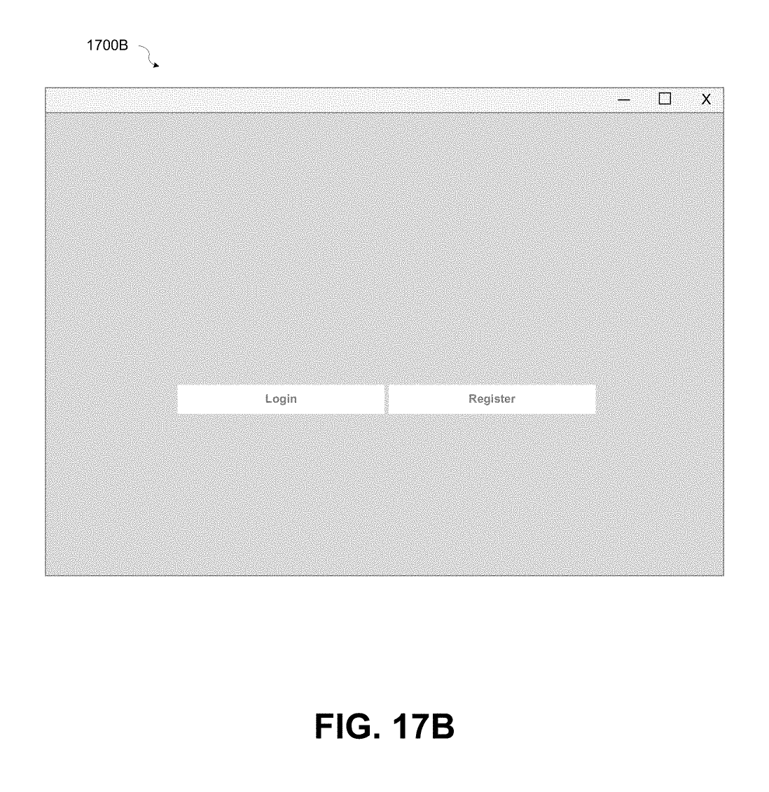

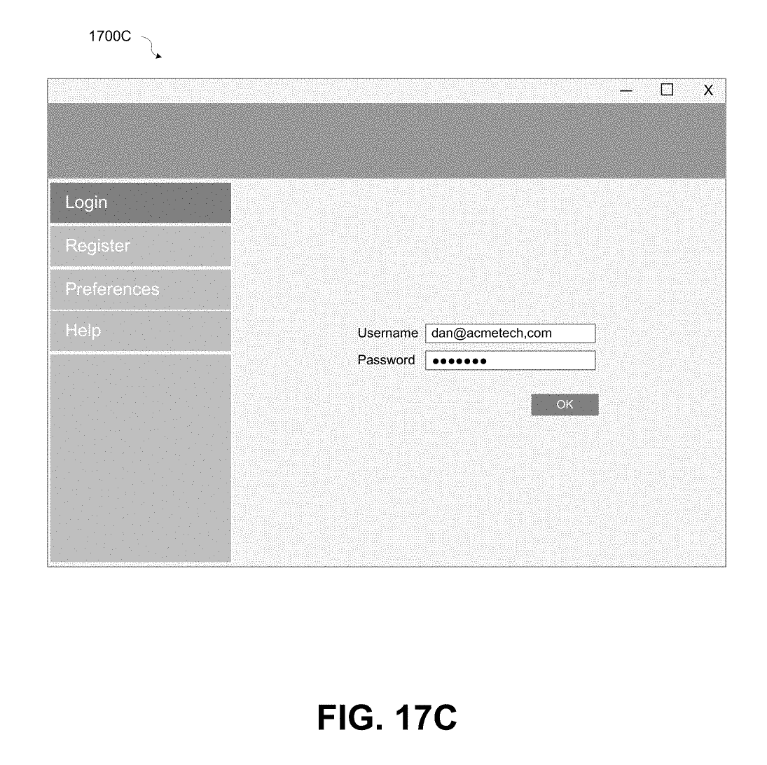

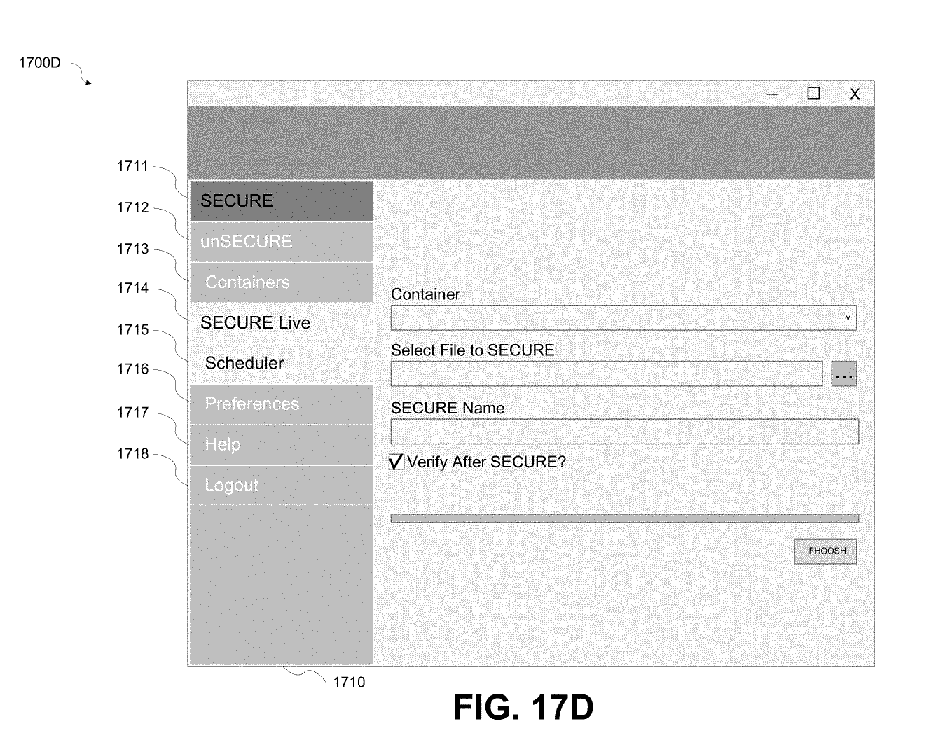

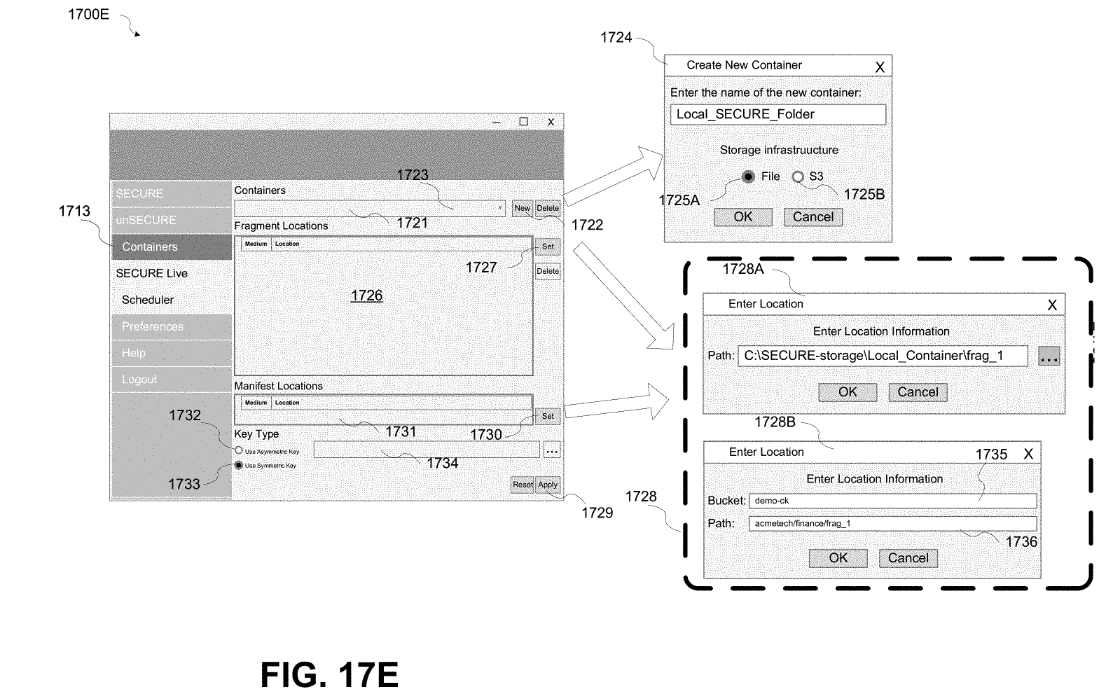

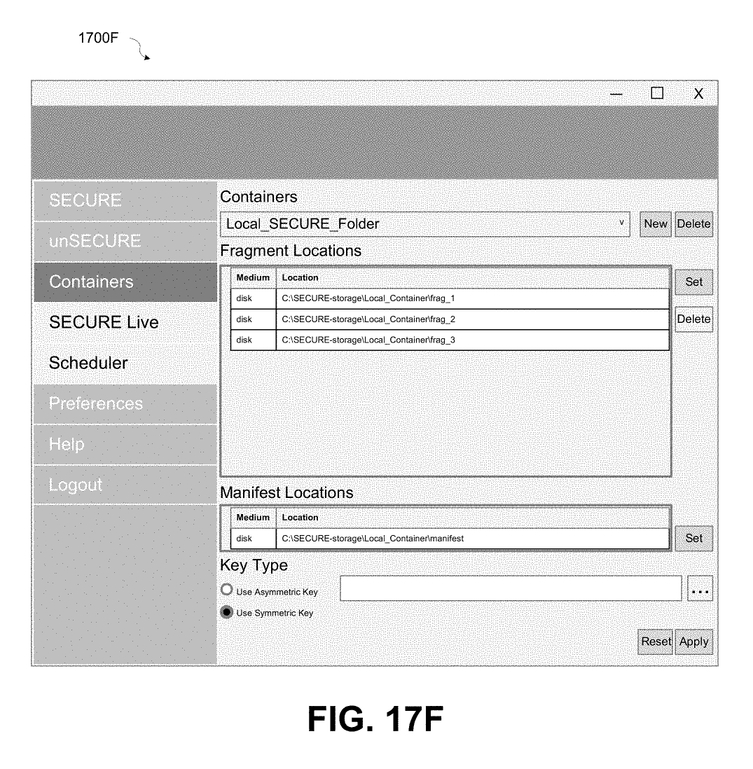

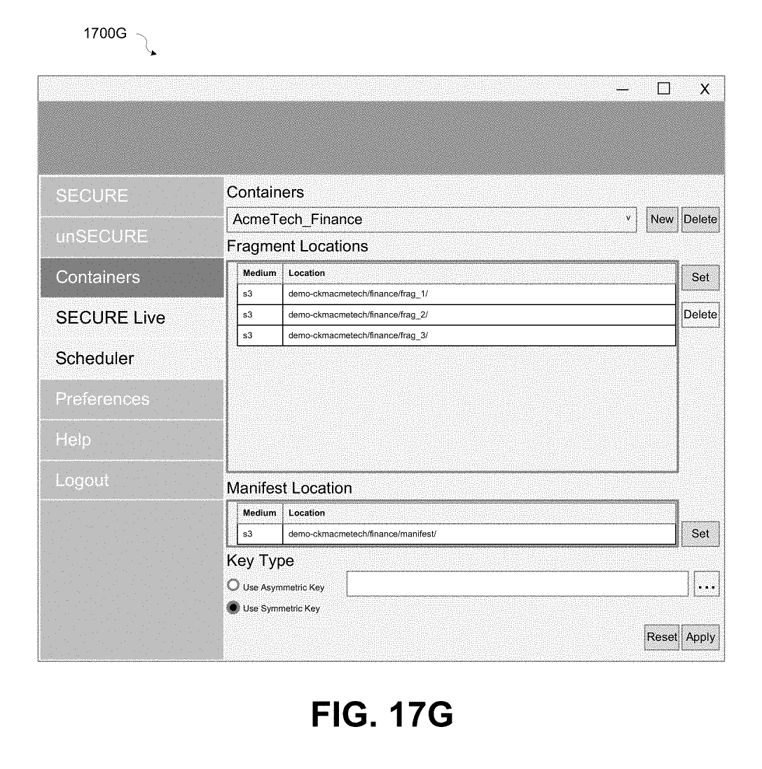

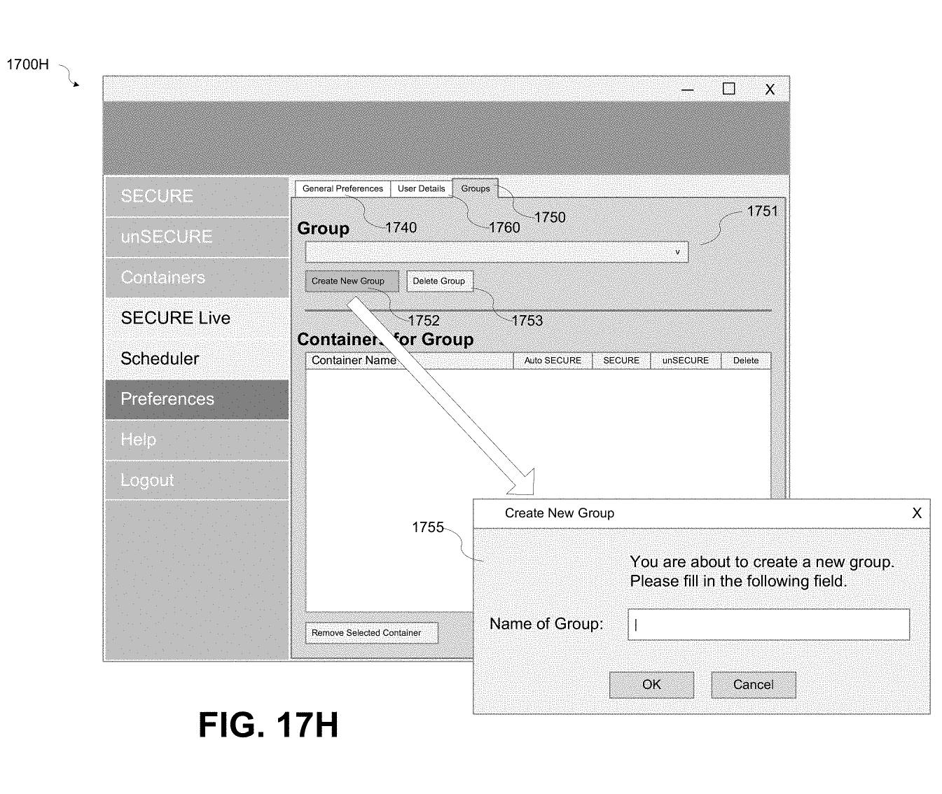

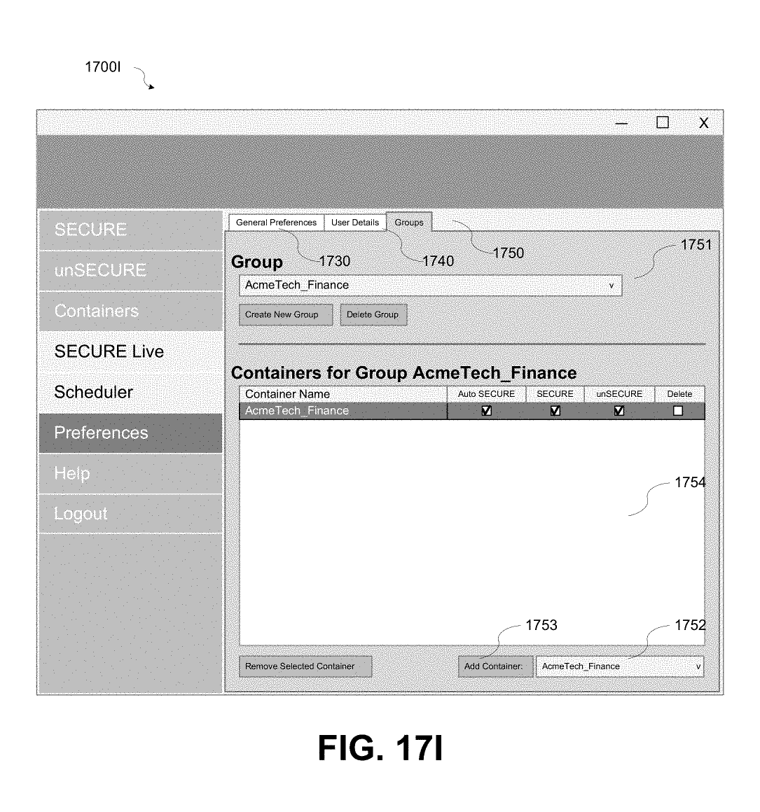

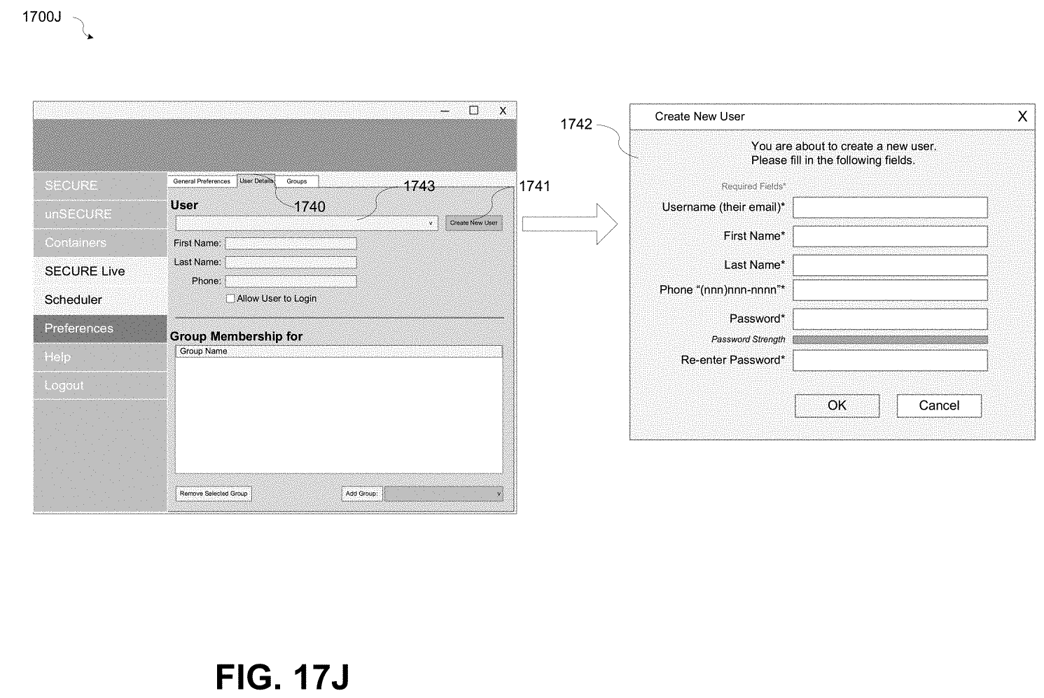

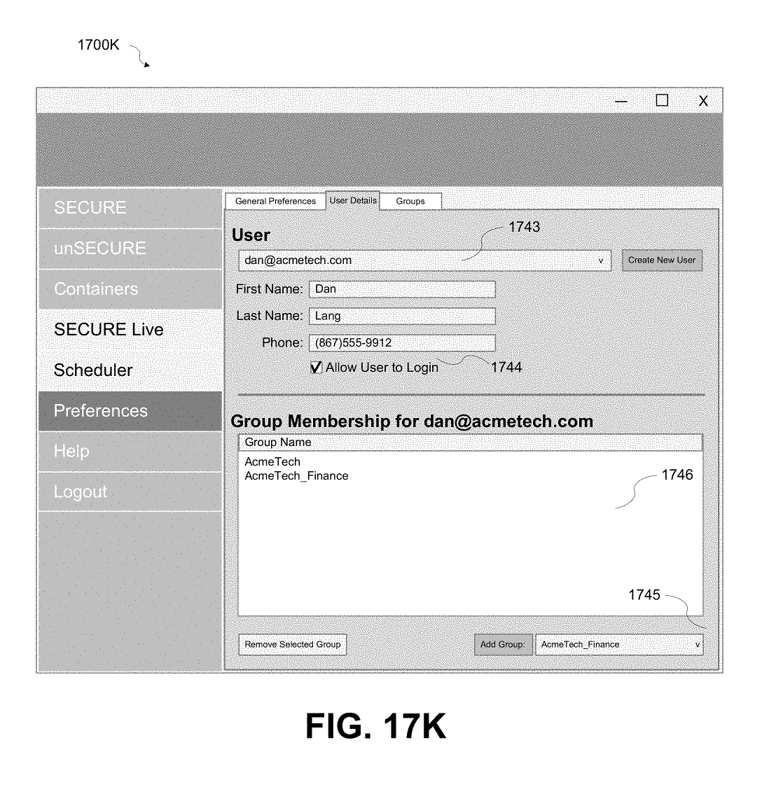

In certain embodiments, users 1610A-C may interact with the application via a graphical user interface displayed by a device and operated by the user for interacting with the application running on the device. The graphical user interface may comprise one or more displayable screens, such as the screens illustrated in FIGS. 17A-19F, as well as other screens described and/or implied herein. While many of the screens of the graphical user interface will be individually described, the described screens simply represent non-limiting, exemplary embodiments of the graphical user interface. The graphical user interface may be implemented in a different manner, with fewer or more of the described screens and/or a different arrangement, ordering, and/or combination of the described screens.

As indicated above, FIGS. 17A-17L illustrate example screen shots of a graphical user interface for interacting with the application installed a user endpoint device (e.g., device 110), through which a user can instruct the application to perform the methods and processes described herein and in the '294, '466, '888, '058, and '*** Applications. The graphical user interface of FIGS. 17A-17L may be displayed on a display device including, but not limited to, a computer monitor, TV, touchscreen display of a mobile device, a laptop display screen, or any other display device that may be apparent to a person of ordinary skill in the art. For example, the graphical user interface may be executed by computer coupled to the systems described herein via a wired and/or wireless connection to a network.

In operation, to begin an administration process, the user operates a device to launch the application. Information about a plurality of users, plurality of groups, and plurality of virtual cryptological containers may be stored in a system, and before logging into the system, the server settings may be required to be configured or otherwise set up. In some embodiments, at initial launch the application may request server settings be configured within the application. In some embodiments, the server settings may be configured by, for example, an administrator or other entity external to the application. The server setting may correspond to information about the server in which various information about users, groups and virtual cryptological containers is stored. The user may retrieve this information from, for example, the administrator and/or other source having access to the server information and then input the information into the server name screen 1700A as illustrated in FIG. 17A.

For example, server settings may be defined during installation of the system, and then provided the user. Once this information is obtained, the user may enter a name that the user selects to refer to the server in the “Nickname” field of screen 1700A. In the “Host Name” field of screen 1700A the user may enter a host name for the server. In some embodiments, if the user wishes to change the default Port Number setting, the user may enter the host port number through which the application will communicate in the ‘Port Number’ field. Once completed, the user may select the ‘OK’ button, and be taken to a screen 1800B as illustrated in FIG. 17B.

In certain embodiments, for subsequent application launches, screen 1700B may be presented to the user. If the user wishes to reset or modify the Server information, the user may access these settings under a “Preferences” option following a login operation as will be described below. From the screen 1700B, a user may authenticate themselves via a “Login” operation at screen 1700C using a credentials for accessing the desired account, for example, username and password. The device may be authenticated by the application and user granted access, for example as described in '888 Application. In some embodiments, the user credentials may be stored in the system in association with one or more of the user accounts, device credentials of the device used to access the application, groups and/or virtual cryptological containers as assigned to the user associated with the credentials.

After successfully authenticating the user and device, the application may generate screen 1700D. As illustrated in FIG. 17D, screen 1700D may comprise a navigation panel 1710 and multiple fields 1720-1723. In certain embodiments, the navigation panel 1710 is presented as at the left margin, however other configurations and positions are possible. For example, the navigation panel 1710 may be on the right, top, or bottom or presented as a drop-down menu.

The navigation panel 1710 comprises a plurality of icons or buttons 1711-1718 for accessing the functionality of the application. For example, button 1711 may permit the user to select data files for secure storage as described herein via the application, for example, in accordance with the '294, '058, and '*** Applications. Button 1712 may be used to securely retrieve and access protected files, for example, in accordance with the '294, '466, '058, and '*** Applications. Button 1713 may be used to access and manage virtual cryptological containers, assignments and configurations as described herein and in accordance with the '058 Application. Button 1714 may be used to access a secure live functionality for secure storage and/or transmission of an encrypted data stream, for example, in accordance with the '*** Application. Button 1716 may be used to access preference setting. From here, the application may be configured to permit the user to select, confirm, modify, etc. data protection preferences, for example, the server settings may be altered as described above. Button 1717 may be used to retrieve contact information for customer services and button 1718 may be used to logout of the application. In some embodiments, the user may be directed to the screen 1700B following logout.

As illustrated in FIG. 1700C, buttons 1714 and 1715 are dimmed or obscured relative to the other buttons indicating that functionality associated with buttons 1714 and 1715 are unavailable to the current user of the application. This may be because the functionality is not yet available or otherwise restricted to the user (e.g., due to assignments of access rights or permissions). While this restriction is illustrated via an obscured button, other methods may be possible, for example, completely removing or hiding the buttons 1715 and 1714 or black out, etc.

If a user wishes to create and/or manage virtual cryptological containers, the user may interact with button 1713 to cause the application to generate screen 1700E of FIG. 17E. From screen 1700E a user may set up and manage virtual cryptological containers, for example, by creating virtual cryptological containers and assigning one or more storage locations to each virtual cryptological container.

In certain embodiments, to create a virtual cryptological container the user may select the ‘New’ button 1723 of the screen 1700E. Selecting the ‘New’ button 1723 may cause the application to generate a second window 1724 in which the user may assign a name to the virtual cryptological container and select a storage infrastructure from one or more storage infrastructures. The second window 1724 may be a completely different screen or a window overlaid on the screen 1700E.

In certain embodiments, one or more storage locations may be one or more storage devices (e.g., hard drives and/or Network File System (NFS) mounts, etc.); a plurality of cloud-based locations (e.g., Amazon S3 and Azure as well as cloud folders, for example, but not limited to, Box, Dropbox, iCloud, Google Drive, OneDrive, or the like); or a combination of both one or more storage devices and one or more cloud-based devices. Second window 1724 illustrates an example whereby the user can select between a first storage infrastructure 1725A (illustrated as one or more local or locally connected storage devices in this embodiment) or a second storage infrastructure 1725B (illustrated as a cloud-based storage device in this embodiment). Other configurations are possible without departing from the scope of the present disclosure, for example, a third infrastructure comprising both the first and second infrastructures. In the example illustrated in FIG. 1700E, the user may select the first storage infrastructure 1725A by interacting with the corresponding ‘File’ button and selecting ‘OK’. In some embodiments, by selecting storage infrastructure 1725A, the application may perform on-premise storage as described, for example, in the '*** Application. In other embodiments, by selecting storage infrastructure 1725B, data may be encrypted and stored as a data stream transmitted to the corresponding storage locations, for example, as described in the '*** Application.

Once the virtual cryptological container has been defined, the application may populate a container field 1721 with the assigned name of the virtual cryptological container. In some embodiments, the container field 1721 may also include a drop-down menu 1721 of various virtual cryptological containers, including currently and previously created virtual cryptological containers. Selecting the drop-down menu may provide the user options to select existing virtual cryptological containers for edit and/or manage existing virtual cryptological containers, as set forth below. When a virtual cryptological container populates the container field 1721, the ‘Delete’ button 1723 may become available, from which a user may choose to delete a virtual cryptological container that populates the container field 1721.

Once a virtual cryptological container is created and/or selected as identified in the container field 1721, the plurality of storage devices may be assigned in which fragments of a file are to be stored for identified given virtual cryptological container. The assigned storage locations may populate the ‘Fragment Locations’ field 1726 once the locations are set up (see, e.g., FIG. 17F). In various embodiments, a ‘Set’ button 1727 may become available when the container field 1721 is populated with a virtual cryptological container name.

Selecting the ‘Set’ button 1727 may cause the application to generate a third window 1728 in which the user may identify a location of a storage device to be assigned to the virtual cryptological container. The third window 1728 may be a completely different screen or a window overlaid on the screen 1700E.

The third window 1728 may be based on the selected storage infrastructure. For example, if the storage infrastructure is set to one or more storage devices (e.g., hard drives and/or Network File System (NFS) mounts), then the third window 1728 may be generated as third window 1728A. In this example, the user may enter a full path name to the directory (e.g., storage location) in the path field where a set of the secured fragments may be stored. In some embodiments, a browser button (shown as ‘. . . ’) may be selected to browse to a directory and populate the path field. Once entered, the user may select ‘OK’ to assign the identified storage location to the virtual cryptological container, and if entered correctly (or access is authorized for this storage location), the system may associate the storage location with the virtual cryptological container identified in the container field 1721.

In another example, if the storage infrastructure is set to one or more cloud-based locations, then the third window 1728 may be generated as third window 1728B. Third window 1728B comprises a bucket field 1735 and a path field 1736. In the bucket field 1735, the virtual cryptological container where a set of the secured fragments may be stored can be labeled (e.g., named) as desired by the user. Next, a path within the virtual cryptological container for where this set of secured fragments may be stored can be entered into the path field 1736. In some embodiments, the bucket field label and path must conform to a set of rules for virtual cryptological containers and paths, respectively, as defined by the cloud server provider (e.g., Amazon, Azure, etc.).

For each example, the above described process may be repeated multiple times to associate a plurality of storage locations with the virtual cryptological container for storing different sets of the secured fragments. Once associated, the storage locations and/or the directory paths may be displayed as illustrated in screen 1700F of FIG. 17F. The ‘Delete’ button may be utilized as needed to remove any incorrectly entered storage locations. However, in some embodiments, once the ‘Apply’ button 1729 has been selected, storage locations may not be static and unchangeable.

The storage location of the manifest may be assigned in a manner similar to that for the storage locations of the fragments as described above. For example, selecting the manifest set button 1730 may cause the application to generate third screen 1728 in which the user may identify a storage location for the manifest. As described above, for a first storage infrastructure, the third screen 1728A may be generated to enter a full path name to the directory (e.g., storage location) in the path field or identified via the browser button. Similarly, the third screen 1728B may be generated for assigning cloud-based storage infrastructure for storing the manifest. Once entered, the user may select ‘OK’ to assign the identified storage location to the virtual cryptological container for storing the manifest, the system may associate the storage location with the virtual cryptological container identified in the container field 1721. Once associated, the storage location and/or the directory path may be displayed in the manifest location field 1731 as illustrated in screen 1700F of FIG. 17F.

Screen 1700E also comprises a key type selection for configuring the encryption scheme for the virtual cryptological container identified in the container field 1721. The user may select between asymmetric key encryption via button 1732 or symmetric key encryption via button 1733. In some embodiments, selecting symmetric key encryption will configure the virtual cryptological container as described above in connection to FIG. 4. For example, the VFS will utilize a symmetric key to encrypt the fragments stored in the storage locations. Alternatively, selecting asymmetric key encryption will configure the virtual cryptological container, for example, to utilize a public key for encryption and a private key for decryption of the fragments stored in the storage locations. Where the asymmetric encryption scheme is selected, the user may be required to populate a key field 1734 with a location of the desired public key corresponding to the private key which will decrypt the fragments.

Selecting the ‘Apply’ button will cause the application to generate the virtual cryptological container as defined in screen 1700F. For example, generating the virtual cryptological container may cause the application to send a command to the system to save the virtual cryptological container and associate above defined parameters with each other and with the virtual cryptological container. The system may save this information in the server for subsequent use (e.g., to assign one or more groups to the virtual cryptological container). The above steps can be repeated multiple times to create as many virtual cryptological containers as needed. FIG. 17G illustrates another example screen 1700G of generating a virtual cryptographic container.

Screen 1700H illustrates a ‘Preference’ screen accessed via button 1716 of FIG. 1700D or any screen comprising said button 1716. From screen 1700H, users and groups may be created and/or managed. Screen 1700H comprises multiple subscreens or tabs, including but not limited to, general preference tab 1740, user details tab 1760, and groups tab 1750. From the groups tab 1750 new groups can be created and virtual cryptological containers assigned to each group. Similarly, from the user tab 1760, users can be registered and/or authorized to access the system, associated with groups, and/or assigned to virtual cryptological containers.

To create a group, a user may interact with (e.g., click, touch, or otherwise input a command) the ‘Create New Group’ button 1752 to generate another window 1755 including a ‘Name of Group’ field. The window 1752 may be a completely different screen or a window overlaid on the screen 1700H. A user may enter a name to correspond to the group in the ‘Name of Group’ field 1755 and select ‘OK’.

The entered group name may then populate the group field 1751, as shown in FIG. 17I. In some embodiments, the group field 1751 may also include a drop-down menu of various groups, including currently and previously created groups. Selecting the drop-down menu may provide the user options to select existing groups for edit and/or to manage existing groups, as set forth below.

Once a group is identified in the group field 1751, one or more virtual cryptological containers can be associated with the group. For example, a virtual cryptological container field 1752 may comprise one or more virtual cryptological containers that are available to be assigned to the group. Field 1752 may be a drop-down menu of virtual cryptological containers or open another window (not shown) comprising a listing of available virtual cryptological containers. Once one of the virtual cryptological containers is selected, the virtual cryptological container may populate the virtual cryptological container field 1752 as shown in FIG. 17I and a user may select to add or assign the identified virtual cryptological container to the group identified in group field 1751. Once selected, the virtual cryptological container will be listed in the assigned virtual cryptological container field 1754 (e.g., “Containers for Group . . .” as shown in the example of FIG. 17I). Multiple virtual cryptological containers can be associated with a given group and may be displayed one per line in field 1754. In some embodiments, for each virtual cryptological container, there may be a plurality of permissions, with default settings as shown in FIG. 17I. The user may adjust the defaults by turning them on/off via the check boxes. Example permissions include, but are not limited to: 1) Auto-protect, which enables/disables the auto-protect functionality as described below; 2) Protect, which enables/disables the capability for a user of the group member to use the application to manually select file(s) to protect and transmit to the chosen virtual cryptological container; 3) Unprotect, which enables/disables the capability for a user of the group member to use the application to retrieve data from the chosen virtual cryptological container and access previously secured files; and 4) delete, which enables/disables the ability for a user of the group to delete previously protected files from within the chosen virtual cryptological container.

In various embodiments, a user can delete the association of a selected virtual cryptological container with a given group, for example, using the delete selected container button as shown in FIG. 17I.

For managing users and assigning users to groups, a user (e.g., an administrator) may navigate to the user tab 1740 to cause the application to generate screen 1700J. Selecting the ‘Create New User’ button 1741 may cause the application to generate another window 1742 that includes a plurality of fields into which information pertaining to the new user may be entered. For example, a username, email, first name, last, name, phone number, password, etc.

Once completed and accepted in the window 1744, the user information may then populate the user field 1743 as shown in FIG. 17K. In some embodiments, the user field 1751 may also include a drop-down menu of various users, including currently and previously created users and self-registered users (as described below). Selecting the drop-down menu may provide the user options to select existing users for managing permissions, group assignments, etc., as set forth below. In some embodiments, a user identified in the user field 1743 may not be permitted to access the application unless check box 1744 is selected permitting the identified user to log in. In some embodiments, check box 1744 permits access where an administrator user has entered the user information, otherwise, the administrator user may be required to select box 1744 to permit access (e.g., in the case of a self-registered user).

Once a user is identified in the user field 1743, one or more groups can be associated with the user. For example, a group field 1745 may comprise one or more groups that are available to be assigned to the user. Field 1745 may be a drop-down menu of groups or open another window (not shown) comprising a listing of available groups. Once one of the groups is selected, the group may populate the group field 1745 as shown in FIG. 17K and a user may select to add or assign the identified group to the user identified in user field 1743. Once selected, the group will be listed in the group membership field 1746. The above may be performed numerous times such that multiple groups can be associated with a given user and be may displayed one per line in field 1746. In various embodiments, a user can delete the association of a selected virtual cryptological container with a given group, for example, using the delete selected container button as shown in FIG. 17I.

In some embodiments, when a new user device (e.g., internet-of-things or IoT device) is to be used for accessing the system, an application may be installed onto the user device to enable the secure storage of data. In some embodiments, installation and setup may be performed by an administrator, for example, as described above. In certain embodiments, the administrator may set up and/or otherwise associate a given user with one or more groups and/or virtual cryptological containers within the system, as described above. The assigned of groups and/or virtual cryptological containers may be done prior to, during, or after registering the device with the system. The system may be set up to store information of a plurality of users in association with a plurality of groups and/or associated with a plurality of virtual cryptological containers. In some embodiments, the plurality of groups may also be associated with one or more of the plurality of virtual cryptological containers, individually, separately, or in combination with the plurality of users.

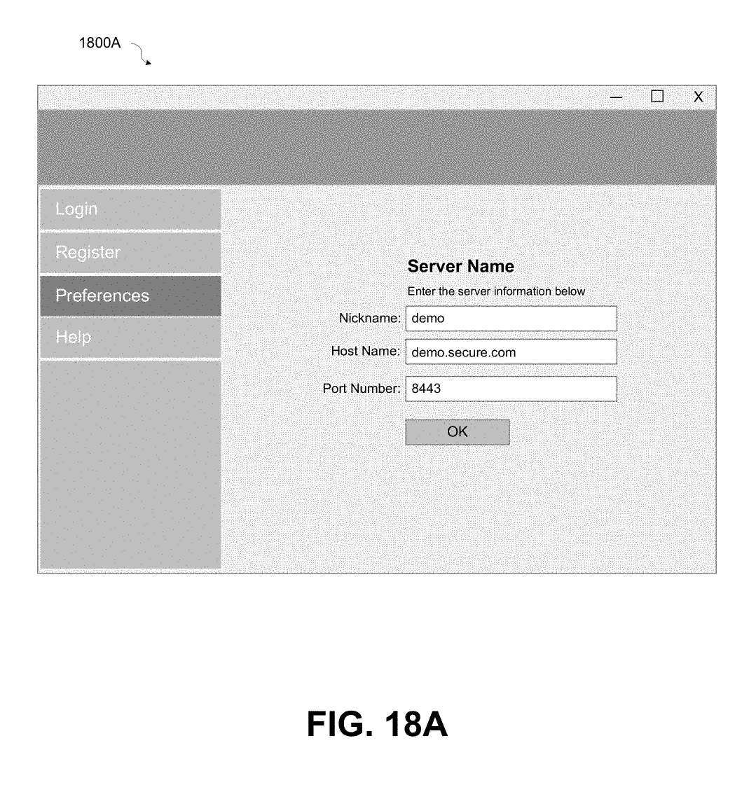

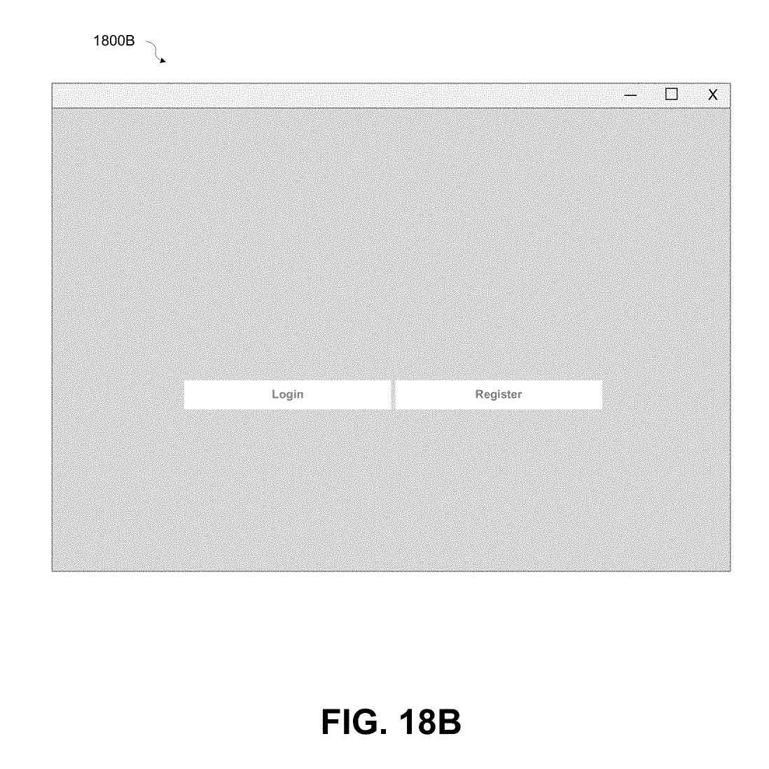

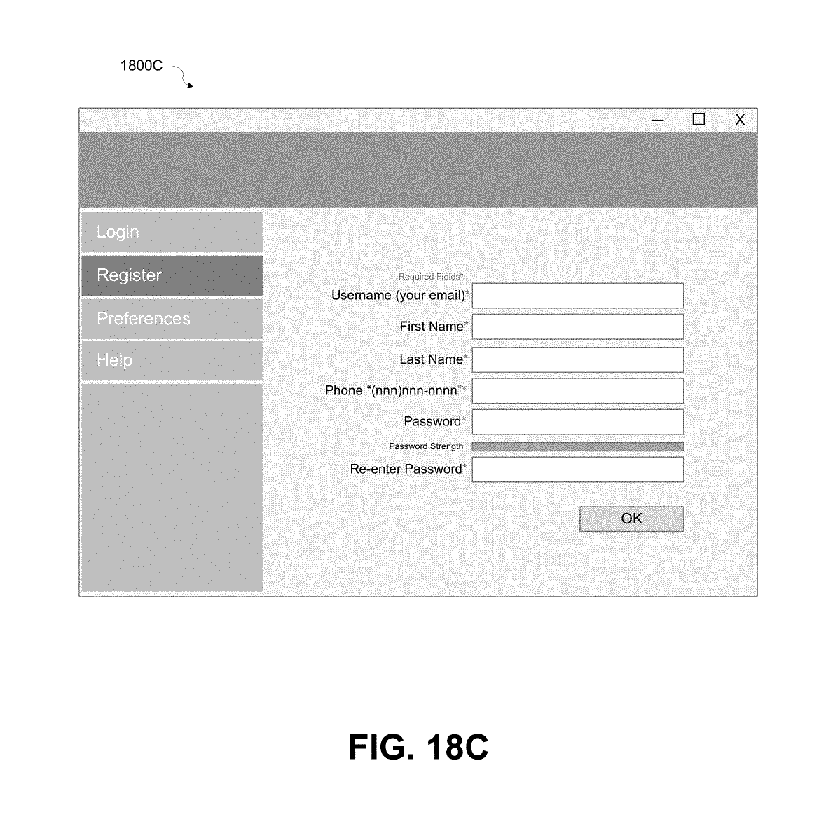

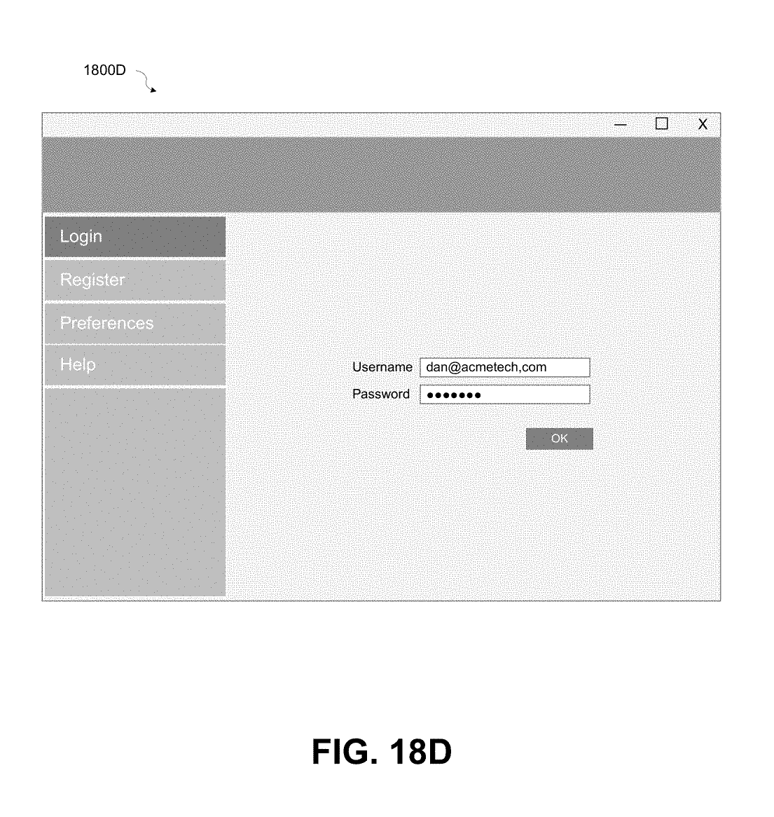

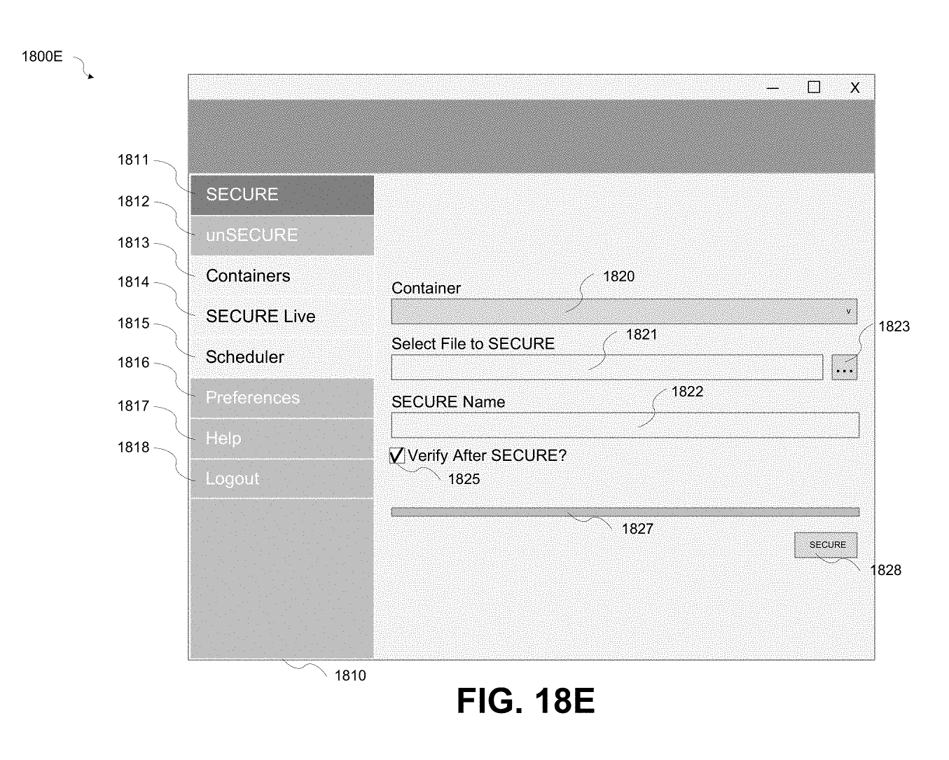

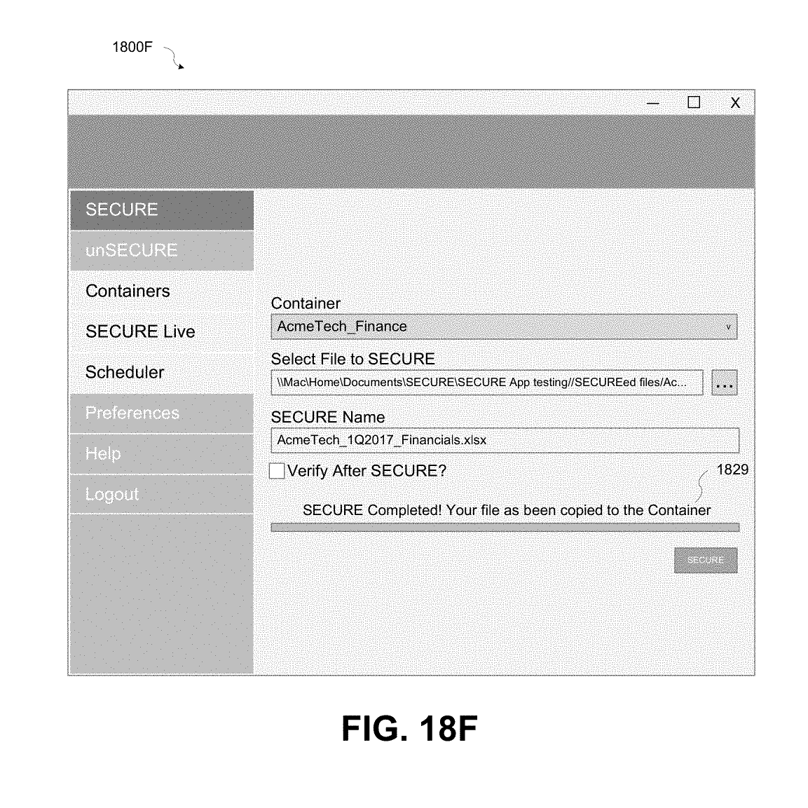

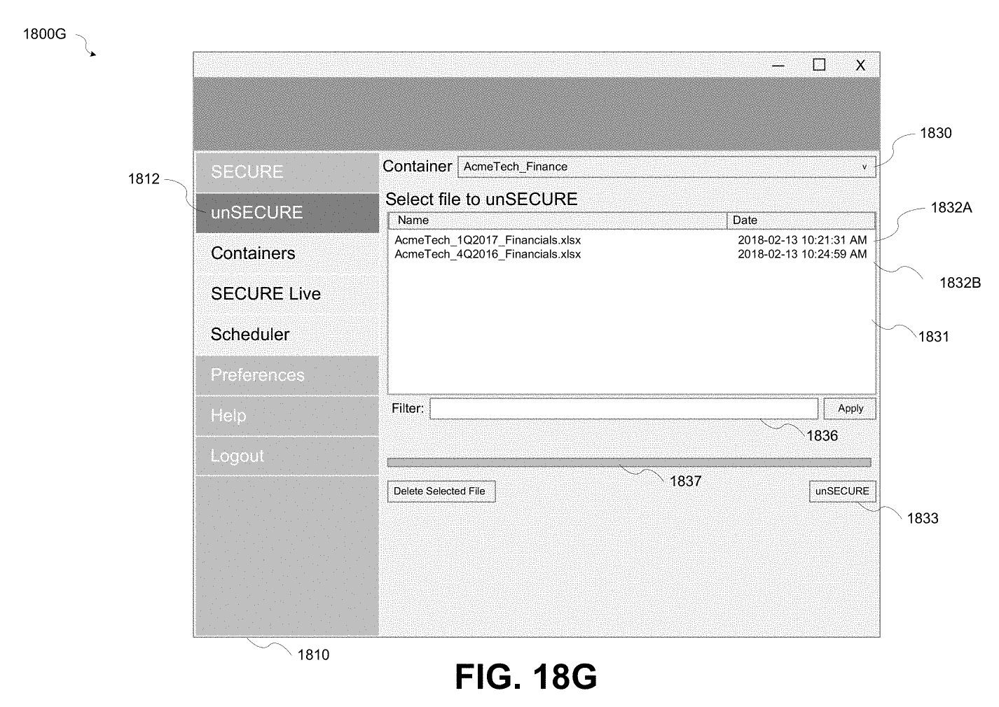

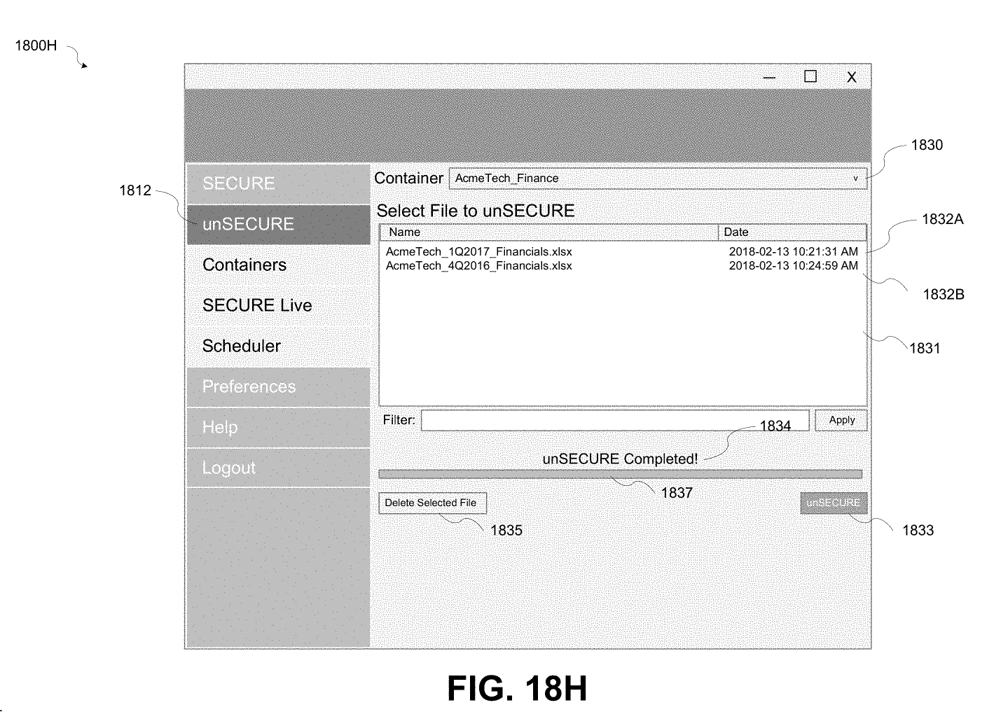

Following installation of the application, the user may select and launch the application. In some embodiments, at initial launch the application may request server settings be defined and set within the application. In some embodiments, the server settings may be defined by, for example, an administrator or other entity external to the application, as described above. The server setting may correspond to information about the system in which various information about users, groups and virtual cryptological containers is stored. The user may retrieve this information from, for example, the administrator and/or other source having the server information and then input the information into the server name screen 1800A as illustrated in FIG. 18A.

For example, an administrator may define server settings, and then provide this information to the user. Once this information is obtained, the user may enter a name that the user selects to refer to the server in the “Nickname” field of screen 1800A. In the “Host Name” field of screen 1800A the user may enter a host name for the server, as defined by the administrator. In some embodiments, if the user wishes to change the default Port Number setting, the user may enter the host port number through which the application will communicate in the ‘Port Number’ field. This information may be supplied by the Administrator. Once completed, the user may select the ‘OK’ button, and be taken to a screen 1800B as illustrated in FIG. 18B.

In certain embodiments, during subsequent launch of the application, the user may be provided screen 1800B. If the user wishes to reset or modify the server information, the user may access these settings under a “Preferences” option following a login operation as described below. From the screen 1800B, a user may either authenticate themselves via a “Login” operation or register a user account and user credentials via a “Register” operation or establish a new user account and credentials.

In various embodiments, to access the system, the user may perform the login operation using a registered account and user credentials, for example, as described in the '888 Application. To register, the user may select the “Register” operation and enter requested credentials in each field as illustrated in FIG. 18C. For example, the user may provide user credentials such as, for example, a username and password. Additionally, a phone number, first name, and last name of the user may also be provided. In some embodiments, the administrator may be required to approve the user credentials after the user enters them. This may be done, for example, by the user completing a self-registration process and the administrator may then go through and approve the appropriate users. The users who go through the self-registration process can be logged and the log can be used to create notices for the administrator or the administrator can choose to just look at the activity logs. Once the “OK” operation is selected, the user may be returned to screen 1800B where they can log in using their user credentials, for example, username and password.

In various embodiments, at screen 1800B the user may perform a “Login” operation, which directs the user to screen 1800D of FIG. 18D. In some embodiments, the user is directed to screen 1800D once they have completed the “Register” operation to register an account, with login credentials approved by the administrator. At screen 1800D, after the user enters the correct credentials, access to the application may be authenticated and user granted access. In some embodiments, the user credentials may be stored in the system in association with one or more of the user accounts, device credentials of the device used to access the application, groups and/or virtual cryptological containers as assigned to the user associated with the credentials. Additional description can be found in the '888 Application.

After successfully authenticating the user's access to the application, the application generates screen 1800E. Screen 1800E may be substantially similar to the screen 1700D described above, except for the given access session of the current user is illustratively shown to not have access rights and is restricted from accessing button 1713 for mapping virtual cryptological containers. This may be because this particular user does not have administrator privileges. In some embodiments, button 1713 need not be obscured if such privileges are associated with the given user. Screen 1800E may also be navigated to via user input with button 1711 from any other screen of the application.

In this scenario, FIG. 18E illustrates a screen shot of a screen 1800E for generating a store command for storing secured data. For example, the application may generate screen 1800E, through which a user may select a file to be protected and a virtual cryptological container in which to store the protected file. Screen 1800E may also be used to generate a store command based on the selected file and virtual cryptological container. Thus, a user may utilize the application to identify a file to be protected and stored using, for example, the VFS 720 described above and as described in the '058 Application.

The data may be stored on any storage device, for example but not limited to, on a local storage, for example, hard drives and/or Network File System (NFS) mounts coupled to the user device, and as well as cloud storage provided by cloud service providers, for example but not limited to, Amazon S3 and Azure as well as cloud folders, for example but not limited to, Box, Dropbox, iCloud, Google Drive, OneDrive, or the like. To secure identified data, the user may select the button 1811 (e.g., click with an input device, touch, or otherwise interact with the application to select the operation). After selecting button 1811, the application may present the screen 1800E and the user may follow the following steps to secure data:
1. Select a virtual cryptological container in the ‘Container’ field 1820. In some embodiments, the field 1820 may be a dropdown menu comprising a list of all virtual cryptological containers assigned to the user. In some embodiments, the field 1820 may generate an overlaid window comprising virtual cryptological containers represented as folders from which the user may select the desired virtual cryptological container. In another embodiment, alone or in combination, the user may enter the virtual cryptological container via an input device (e.g., I/O interface of FIG. 5).
2. Use the ‘. . . ’ file browser icon 1823 to browse storage locations for the desired file. For example, the icon 1823 may generate a second screen (not shown) through which the user may browse various storage locations, for example, but not limited to, local storage, for example, hard drives and/or Network File System (NFS) mounts coupled to the user device, and/or cloud storage provided by cloud service provide, as described above. The second screen may be overlaid on the screen 1800E or otherwise presented to the user. The browser may be presented as one or more folders or directories through which the user browses to select the desired data to be protected. Once desired data is selected, field 1821 may be automatically populated with the storage location and name of the data to be protected.
3.Field 1822 is populated with a name to be associated with the protected data and manifest as associated with the selected virtual cryptological container. In certain embodiments, field 1822 may be automatically populated with the name of data selected via icon 1823. Optionally, the user may select to either leave the entry in the field 1822 as-is or enter an alternative name if the user wishes to change the name when stored in the virtual cryptological container. In various embodiments, the same name may not be used within a given virtual cryptological container more than once, thus each data object may be required to have a different name. If there is a collision (e.g., the user attempts to use an already used name), the system may overwrite the existing data or prompt the user for confirmation to overwrite the exiting data.
4. Optionally, the application may execute a verify operation to confirm that the protected data has been secured and transmitted via the application to the selected virtual cryptological container. In some embodiments, the verify operation may be enabled for a given protection operation by clicking or otherwise interacting with the “Verify” checkbox icon 1825. Verification may be performed by generating a temporary copy of the protected data, unprotecting the temporary copy, performing a comparison (e.g. a binary comparison or the like) of the originally selected data against the unprotected temporary copy to confirm they are the same, and then deleting the temporary copy. In some embodiments, the temporary copy is generated immediately following the creation of the protected data in the following step.

In some embodiments, opposed to a temporary copy, verification may be performed by checking what was written to storage locations (e.g., disc) matches what is in memory and was expected to be written. In this scenario, verification may include comparing encrypted data so decryption of a temporary copy (e.g., an unsecure copy) is not required. In some implementations, when encrypting fragments, the fragments may be decrypted in memory to ensure that the encryption is reversible. Then, the encrypted fragments may be written to storage location (e.g., to disk) and read back, verifying that encrypted data was written properly. The written data is only read, so no temporary file needs to exist. In some embodiments, where reading the file would be time consuming due to poor network throughput (e.g., such as a cloud), verification may include creating a checksum of the data being written and compare the checksum with the data written to the storage locations. In the case of cloud storage, a cryptographic hash of each fragment may be sent to the storage server which may verify that the data matches the hash (as opposed to retrieving the entire fragment and using excessive network bandwidth). If the checksums match, the data is considered verified. In various embodiments, the above may also apply to the manifest as well and takes place on a per-manifest, per-fragment basis, and so there does not need to be a particular number of fragments or manifests completed before verification takes place.
5. Lastly, the application may be instructed to execute the methods described herein, for example, to securely store the selected data object in the selected virtual cryptological container via user interaction with button 1828. In some embodiments, button 1828 may not be available or otherwise obscured until the earlier described steps are completed. In some embodiments, interaction with icon 1828 may instruct the application to generate a store command that may be received by the system as described above and in the '058 Application.

Screen 1800E shown in FIG. 18E also comprises a status bar 1827. In various embodiments, as the selected data is fragmented and stored into the virtual cryptological container in accordance with embodiments described herein, the status bar 1827 may be configured to show a current status and/or a real-time completion progress of the protection operation.

In certain embodiments, where “Verify” checkbox icon 1825 is selected or otherwise enabled, the verification operation may be initiated upon completion of the protection operation. In some embodiments, verification operation initiate be a command to retrieve the secured data object, for example, as described above and in the '058 Application. For example, by generating a command to access the protected file immediately following completion of the protection operation. However, unlike a standard retrieval request, the resulting reassembled and decrypted file is a temporary file for verifying that the secured file is complete and uncorrupted. In some embodiments, the status bar 1827 may be reset to show verification progress. In another embodiment, a second status bar (not shown) may be generated that shows verification progress.

Once the secure operation has been successfully completed (and verified if enabled), a completion message 1829 may be generated and displayed on, for example, screen 1800F. Screen 1800F may be substantially similar to screen 1800E, except that the various fields 1820-1828 have been populated and the completion message 1829 generated, as shown. In certain embodiments, if the file associated with the selected name already exists within the virtual cryptological container, the application may generate an automated message that the secure operation failed because the destination file already exists. In some embodiments, to save the secured file, a different name must populate field 1822 and the secured operation performed again via button 1828. In some embodiments, the application may check for the selected virtual cryptological container for destination file name at the beginning or during the protection operation, such that the application need not restart the entire operation.

FIG. 18G illustrates a screen shot of a screen 1800G for generating a command to access a protected file stored in the system. For example, the application may generate screen 1800G, through which a user may locate a secured file to be accessed for viewing, interacting with, and/or storage for full accessibility by the user. Screen 1800G may also be used to generate a retrieve or access command based on a selected protected file, as described above and in the '058 Application.

The screen 1800G may comprise a virtual cryptological container field 1830, a secured data field 1831, and a retrieve command button 1833. The user may populate the virtual cryptological container field 1830 with desired virtual cryptological container, select a desired protected file in the secured data field 1831 to retrieve, and interact with the retrieve button 1833 to generate a command to access the file in accordance with the present disclosure. In some embodiments, the virtual cryptological container field 1830 is a drop-down menu listing one or more virtual cryptological containers associated with the user. In another embodiment, interaction with the virtual cryptological container field 1830 may generate a browser that the user may navigate to select the desired virtual cryptological container for populating the virtual cryptological container field 1830. The secured data field 1831 may be populated based in part on the virtual cryptological container identified in the virtual cryptological container field 1830. For example, the secured data field 1831 may comprise a plurality of files that are stored in the virtual cryptological container used to populate the virtual cryptological container field 1830. FIG. 18G illustrates two secured files 1832A and 1832B associated with the identified virtual cryptological container; however, any number of secured files may be associated with the virtual cryptological container based on the number of files that have been stored in association with the virtual cryptological container.

FIG. 18H depicts screen 19H illustrative of a completed unsecure operation, for example, on secured files 1832A and 1832B, Screen 18H comprise a filter field 1836, a status bar 1837, and a delete selected file button 1835.

In operation, to select and retrieve a secured file to a local or locally mounted drive and render it fully accessible, a user may interact with button 1812 in the navigation panel 1810. This may cause the application to display screen 1800G and the user may follow the following steps to retrieve and access protected data:
1. Select a virtual cryptological container from the virtual cryptological container field 1830. As described above, this field may be a drop-down menu comprising one or more virtual cryptological containers associated with the user. This field may also generate a browser through which a user may navigate to a desired virtual cryptological container. Once the virtual cryptological container is selected such that it is displayed in the virtual cryptological container field 1830, one or more protected files stored in association with the virtual cryptological container are selectably displayed in the protected data field 1831.
2. One or more protected files may be selected from the secured data field 1831 for retrieval. For example, the user may click or otherwise interact with one or more and/or a plurality of the listed protected files to identify the protected files the user desires to access. In this example, the user may select one or more of secured files 1832A and/or 1832B. In some embodiments, the number of secured files in field 1831 may be filtered via the filter field 1836. For example, the user may utilize any filter (e.g., a text-matching filter or the like) to locate desired protected files.
3. Once the desired protected files are selected, the application may generate a command to access the protected files via interaction with the retrieve button 1833. For example, the user may click or select the retrieval button 1833. Upon interacting with button 1833, the application may generate a prompt to select a directory within a local or locally mounted storage device the user would like to store the retrieved and decrypted file. The prompt may be generated as browser and/or file manager overlaid on top of screen 1800H through which the user may navigate to the desired directory.
4. After selecting the destination folder location, the access command may be transmitted to the system, for example, as described above and in the '058 Application. If access to the protected file is authorized, the encrypted file fragments may be retrieved from the storage locations mapped via the virtual cryptological container, decrypted, and reassembled as described herein. During this process, the status bar 1837 may show completion progress. Once the file has been successfully retrieved and decrypted, the bar will be completely filled, and a completion message 1834 may be displayed.

In some embodiments, if the retrieved and decrypted file already exists in the destination folder, the application will prompt the user to decide to replace the previously saved file. If the user selects ‘Yes,’ the existing file on the destination folder will be replaced. If the user selects ‘No,’ the user can choose another destination folder, or cancel the decryption operation altogether.

The delete selected file button 1835 may be used to delete and completely remove a selected file from the system. For example, the user may select a file from the protected file field 1831 and interact with the button 1835 to remove the file from the system 200. In some embodiments, to delete a file, the application first detects that the delete selected file button 1835 has been selected. As with the above described process, the user then selects the virtual cryptological container and the file associated with that virtual cryptological container to be deleted.

FIG. 18I illustrates a screen shot of a screen 1800I for viewing, modifying, or entering certain preferences for operation of the application. For example, by selecting button 1816 the application may retrieve and present one or more preference screens. In one embodiment, the button 1816 may retrieve and present the server setting screen 1800A as described above, from which the user may alter the server settings. In another embodiment, selecting the preference button 1816 may cause the application to retrieve and present a general preference screen 18001. The general preference screen 1840 may comprise various settings for the operations described herein, for example protecting selected files and/or retrieving selected protected files.

In the illustrated embodiment of FIG. 18I, the screen 1840 comprises a “Verify” checkbox icon 1841 and auto-secure option settings 1842. The “Verify” checkbox icon 1841 may be substantially similar to the “Verify” checkbox icon 1825 described above in connection to FIG. 18E. However, by selecting the “Verify” checkbox icon 1841 within the preference screen 1840, the application may set to default performing the verify operation. That is, the application can be set to perform the verify operation for each store command unless otherwise instructed (e.g., by turning the option off when selecting to protect a desired field) by the user and/or application.

The auto-secure operation 1842 may be utilized to configure the application to automatically secure and transmit files based on dragging and dropping them into a predefined directory. In some embodiments, the auto-secure operation may be implemented via API(s) and/or CLI(s) that interface the application with one or more other applications (e.g., third party applications) running on the device. The directory and desired virtual cryptological container may be set in the auto-secure directory field 1843 and auto-secure container field 1844, respectively. By configuring the application to utilize the auto-secure features, the user can quickly and easily select files for protection, without having to access the application directly.

For example, to configure the auto-secure functionality, a desired directory may be selected by clicking on the ‘. . . ’ button 1847 to generate a browser from which a desired directory may be identified. The directory may be associated with a local or locally mount storage device or a cloud service provided. The identified directory in the auto-secure directory field 1843 corresponds to the directory in which a user will be able to drag/drop files into to be automatically secured, transmitted and stored via the system. The drag/drop operation may be similar to any file manager or browser application. The desired virtual cryptological container can be selected via the auto-secure container field 1844, which may be similar to the container fields 1830 and/or 1820 described above. The selected virtual cryptological container will be associated with the selected directory such that any files dragged into the selected directory will automatically be secured and stored in the selected virtual cryptological container. Optionally, the verification operation may be selected for the auto-secure functionality via a “Verify” checkbox icon 1845. Thus, any files dropped into the selected directory will be auto-protected and stored in the virtual cryptological container, and the verification operation will be performed on each stored file in the virtual cryptological container. In some embodiments, an optional delete functionality may be enabled via the delete checkbox icon 1846. This feature may be enacted to delete the original file from the auto-protect directory it has been stored in and stored in the virtual cryptological container. Once the preferences are set, the auto-secure functionality may be initiated by selecting the start auto-secure button 1848.

In some embodiments, the application may generate an error message if the auto-secure directory is not empty or does not exist during setup. In various embodiments, the auto-protect functionality may be active only when the application is running and/or operating. In some embodiments, after starting the auto-secure functionality via button 1848, a stop button (not shown) may be generated either in place of or in a difference position of the start button 1848. The stop button may be used to disable the auto-secure operation.

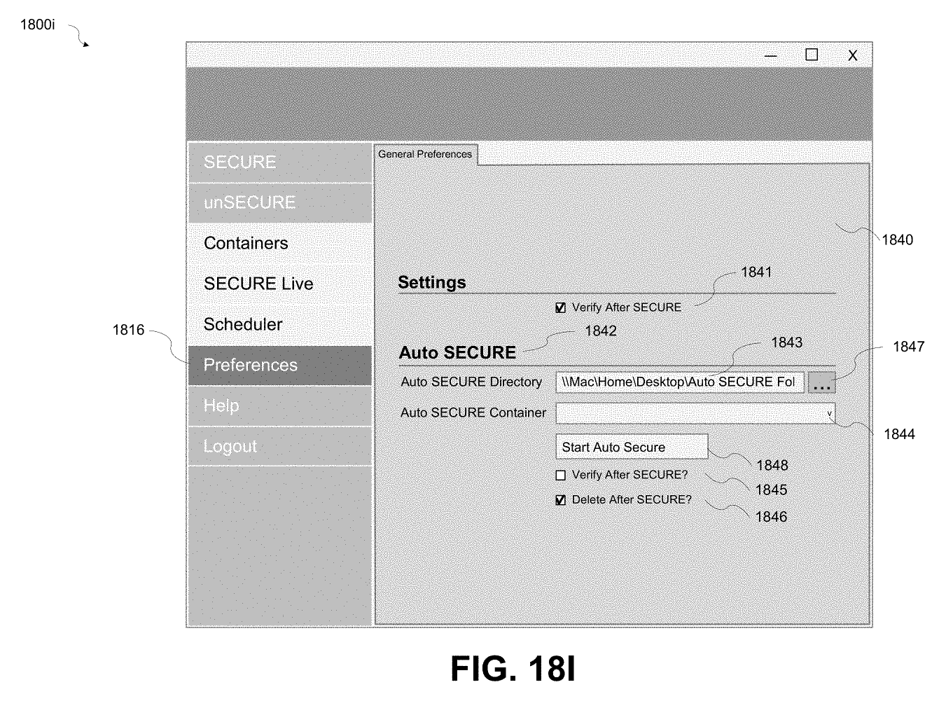

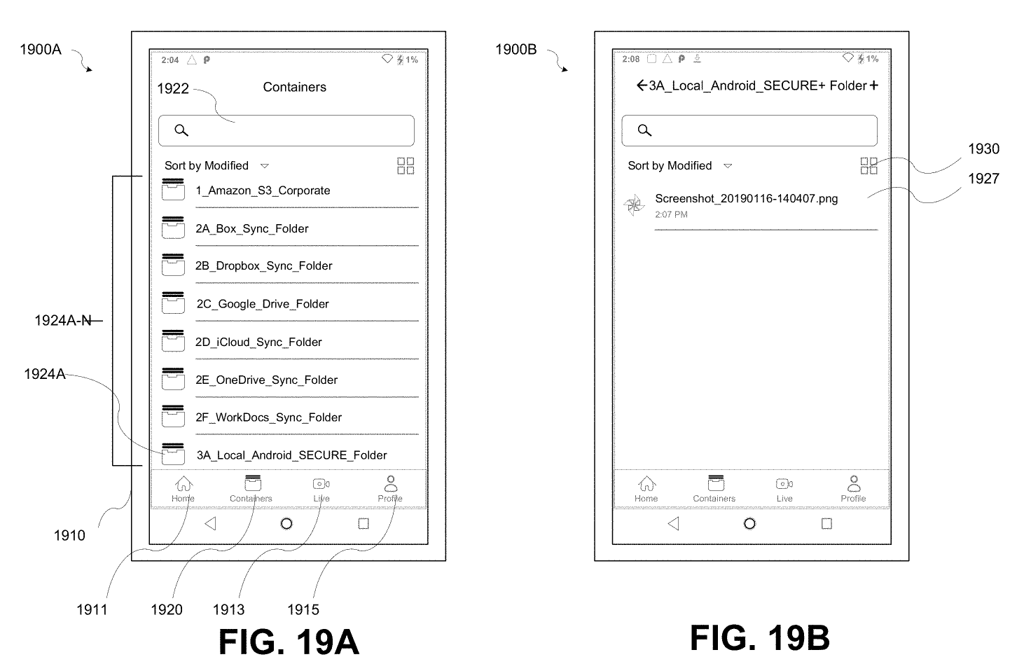

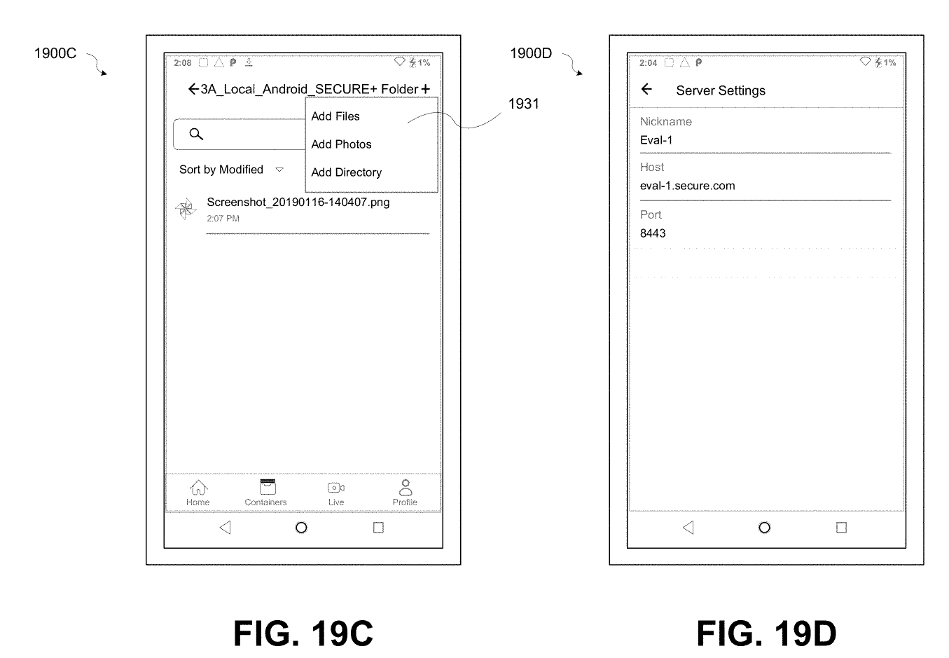

FIGS. 19A-19D illustrate example screen shots of another graphical user interface of interacting with an application installed onto a user device, through which a user can interact with the systems in accordance with the disclosure herein. The graphical user interface of FIGS. 19A-19F may be displayed on a display device including, but not limited to, a touchscreen display of a mobile device, computer monitor, TV, a laptop display screen, or any other display device that may be apparent to a person of ordinary skill in the art. For example, the graphical user interface illustrated in FIGS. 19A-19D is illustratively executed on a mobile device communicatively coupled to the systems described herein via a wired and/or wireless connection to a network. In some embodiments, the mobile device may be operating an operating system, such as but not limited to, Android by Google, iOS by Apple, etc.

In various embodiments, the user of the device may be required to authenticate themselves for access the application. For example, as described above, when paired with a remote key server, the system may be configured to transparently authenticate the user and retrieve the corresponding key(s) on a per-file and/or per-access basis.

After successfully authenticating the user's access to the application, the application may generate screen 1900A. Screen 1900A comprises navigation bar 1910 illustratively disposed along a lower edge of the screen 1900A; however, the navigation bar 1910 may be positioned anywhere in the display. The navigation bar 1910 comprises a plurality of icons, for example, an icon 1911 for accessing a home screen (not shown); an icon 1913 for accessing other functionality of the application, for example, as described in the '*** Application; an icon 1915 for accessing a profile screen (not shown), and an icon 1920 for accessing screen 1900A for selecting a virtual cryptological container in a manner similar to that described above.

Screen 1900A comprises a search bar 1922 and a list of a plurality of virtual cryptological containers 1924A-N. The virtual cryptological containers 1924A-N may be substantially similar to the virtual cryptological containers described herein. From screen 1900A, a user may interact with the device to select a virtual cryptological container for secure storage of data. The user may interact with the device by, for example, interacting with a touch screen via a finger press, voice command, or other input device (e.g., I/O interface of FIG. 5).

Once a user selects a virtual cryptological container from the list, the application generates screen 1900B. Screen 1900B illustrates a graphical interface representative of data securely stored in the selected virtual cryptological container. For example, in the illustrative embodiment the user selected virtual cryptological container 1924A. Thus, screen 1900B illustrates the contents 1927 securely stored in virtual cryptological container 1924A, for which the user is authorized to access. In some embodiments, if the user is not authorized to access the selected virtual cryptological container, the selected virtual cryptological container may appear empty at screen 1900B. In some embodiments, if the user is not authorized to access virtual cryptological container 1924A, screen 1900B is not generated and the user is not permitted to view contents therein. In some embodiments, only those virtual cryptological containers that the user is authorized to access may be displayed. While one document is shown in FIG. 19B for illustrative purposes, it will be understood that any number of securely stored data objects may be displayed.

In some embodiments, the user may interact with screen 1900B to select data for storage within the selected virtual cryptological container in accordance with disclosure herein. For example, a user may interact with icon 1930 to identify data for storage within virtual cryptological container 1924A. User interaction with icon 1930 may generate a drop-down menu 1931 shown in FIG. 19C comprising multiple data types for storage. For illustrative purposes, FIG. 19B illustrates example data types including, but not limited to, files, photos, and directories that may be selected for secure storage. However, other data types may be listed, for example, videos, software, documents, etc. Furthermore, selecting directories may navigate the user to another a file manager depicting numerous directories from which the user may identify a desired directory for secure storage (e.g., storing the entire contents of the selected directory). The user may select one or more data objects therein for secure storage via the application. In some embodiments, selection of data to be secured via screen 1900C may also generate a store command as described above and in the '058 Application based on the selected file and virtual cryptological container.

Returning to screen 1900B, the user may interact with the data object 1927 to generate a command to access or retrieve a protected file. For example, the application may generate screen 1900B, through which a user may locate a protected file to for viewing, interacting with, and/or storage for full accessibility. For example, in some embodiments, a protected file may be selected at screen 1900B for storage in a storage location local or locally connected to the device (e.g., on-premise storage as described in the '*** Application). In another embodiment, alone or in combination, the protected file may be selected for viewing via a data stream from the storage locations, for example, as described in the '*** Application. Screen 1900B may also be used to generate a retrieve or access command (e.g., command to access of block 619 of FIG. 6) based on a selected protected file.

FIG. 19D illustrates a screen shot of a screen 1900D for viewing, modifying, or entering certain preferences for operation of the application. In some embodiments, screen 1900D may be accessed via profile icon 1915. For example, by selecting icon 1915 the application may retrieve and present one or more preference screens. In one embodiment, the icon 1915 may retrieve and present the server setting screen 1900D, from which the user may alter the server settings. For example, the server settings screen 1900D may provide the ability to specify one or more servers where user accounts are stored.

### 11. Additional Features

While various embodiments have been described above, it should be understood that they have been presented by way of example only, and not of limitation. The breadth and scope should not be limited by any of the above-described exemplary embodiments. Where this document refers to technologies that would be apparent or known to one of ordinary skill in the art, such technologies encompass those apparent or known to the skilled artisan now or at any time in the future. In addition, the described embodiments are not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the described embodiments.

Furthermore, although items, elements or components can be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases can be absent.

While various embodiments have been described above, it is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A system for storing a data object, comprising:
a trusted file manager system comprising a plurality of data repositories corresponding to a plurality of storage locations;
a secure server; and
a client device comprising and an application running on the client device and one or more processors, the application communicatively coupled to the secure platform and the trusted file manager system, the application configured to:
select a data repository, the data repository associated with a data map of one or more of the plurality of storage locations corresponding to the data repository, and
send a request to store the data object with the data repository,
wherein, in response to the request to store the data object, the data object is disassembled into a plurality of data fragments, the plurality of data fragments are individually encrypted, and the encrypted data fragments are stored to the one or more of the plurality of storage locations in accordance with the data map.

2. The system of claim 1, wherein the one or more of the plurality of storage locations comprises one or more of a cloud storage platform, a cloud folder, and a local storage media.

3. The system of claim 1, wherein the application is configured to authenticate a user of the client device based on user credentials, wherein selection of the data repository is based on successfully authenticating the user.

4. The system of claim 1, wherein the application is configured to authenticate the client device based on client device credentials, wherein selection of the data repository is based on successfully authenticating the client device.

5. The system of claim 1, wherein the client device is configured to send the request via an application programming interface (API) of the application running on the client device.

6. The system of claim 5, wherein the application running on the client device is executed as one or more APIs of a software development kit (SDK) stored in a memory of the client device.

7. The system of claim 1, wherein the application is configured to send the request to store the data object to the secure server, wherein the secure server is configured to disassemble the data object, encrypt the plurality of data fragments, and store the encrypted data fragments to the one or more of the plurality of storage locations in accordance with the data map.

8. The system of claim 1, wherein the application is configured disassemble the data object and encrypt the plurality of data fragments, wherein the secure server is configured to store the encrypted data fragments to the one or more of the plurality of storage locations in accordance with the data map.

9. The system of claim 1, wherein the application is configured to:
verify the storage of the data object with the data repository,
wherein, verification comprises, copies of the encrypted data fragments are generated, retrieved from the one or more of the plurality of storage locations in accordance with the data map, decrypted, and reassembled into a temporary data object, the temporary data object is compared against the data object to confirm the storage of the data object was successful, and, in response to the confirmation, delete the temporary data object.

10. The system of claim 1, wherein the data map comprises mapping information for storage to one or more of the plurality of storage locations corresponding to the data repository.

11. The system of claim 10, further comprising an administrator device comprising the application running on the administrator device and configured to: generate the mapping information based in part on creating the data repository and an encryption algorithm for encrypting the plurality of data fragments.

12. The system of claim 10, further comprising an administrator device comprising the application running on the administrator device and configured to: assign the data repository to a user of the client device, wherein the user is included in a group of users comprising common authentication parameters.

13. The system of claim 1, wherein the application is configured to automatically trigger sending the request via an application programming interface (API) of the application in response to receiving a user input selecting the data object for storage.

14. A system for accessing a data object, comprising:
a plurality of storage locations configured to store encrypted data fragments;
a trusted file manager system comprising a plurality of data repositories each associated with a data map of one or more of the plurality of storage locations corresponding to a respective data repository;
a secure server; and
a client device comprising and an application running on the client device and one or more processors, the application communicatively coupled to the secure platform and the trusted file manager system, the application configured to:
select a data repository, the data repository comprising at least the data object, and
send a request to access the data object from the selected data repository,
wherein, in response to the request to access the data object, a plurality of encrypted data fragments are retrieved from the one or more of the plurality of storage locations in accordance with the data map associated with the data repository, the plurality of encrypted data fragments are decrypted, and the data object is reassembled from the decrypted data fragments.

15. The system of claim 14, wherein the one or more of the plurality of storage locations comprises one or more of a cloud storage platform, a cloud folder, and a local storage media.

16. The system of claim 14, wherein the application is configured to authenticate a user of the client device based on user credentials, wherein access to the data object is based on successfully authenticating the user.

17. The system of claim 14, wherein the application is configured to authenticate the client device based on client device credentials, wherein access to the data object is based on successfully authenticating the client device.

18. The system of claim 14, wherein the application is configured to authenticate a user of the client device based on user credentials, wherein access to the data repository is based on successfully authenticating the user.

19. The system of claim 14, wherein the application is configured to authenticate the client device based on client device credentials, wherein access to the data repository is based on successfully authenticating the client device.

20. The system of claim 14, wherein the client device is configured to send the request via an application programming interface (API) of the application running on the client device.

21. The system of claim 20, wherein the application running on the client device is executed as one or more APIs of a software development kit (SDK) stored in a memory of the client device.

22. The system of claim 14, wherein the application is configured to send the request to access the data object to the secure server, wherein the secure server is configured to retrieve and decrypt the plurality of encrypted data fragments and reassemble the data object from the decrypted data fragments.

23. The system of claim 14, wherein the secure server is configured to receive the request to access the data object from the application, retrieve the plurality of encrypted data fragments from the one or more of the plurality of storage locations in accordance with the data map, and transmit the plurality of encrypted data fragments to the client device, wherein the application is configured to decrypt the plurality of encrypted data fragments and reassemble the data object from the decrypted data fragments.

24. The system of claim 14, wherein the plurality of decrypted data fragments are decrypted using a manifest corresponding to the data fragments, the manifest stored to a storage location of the plurality of storage locations.

25. The system of claim 14, wherein the data map comprises mapping information for storage to the one or more of the plurality of storage locations corresponding to the data repository.

26. The system of claim 25, further comprising an administrator device comprising the application running on the administrator device and configured to: generate the mapping information based in part on creating the data repository and an encryption algorithm for encrypting the plurality of data fragments.

27. The system of claim 25, further comprising an administrator device comprising the application running on the administrator device and configured to: authorize access to the data repository by a user of the client device, wherein the user is included in a group of users comprising common authentication parameters.

28. The system of claim 14, wherein the application is configured to automatically trigger sending the request via an application programming interface (API) of the application in response to a receiving a user input selecting the data object for access.

29. A system for managing storage and access to a plurality of data objects, comprising:
a plurality of storage locations configured to store encrypted data fragments of the plurality of data objects;
a trusted file manager system comprising a plurality of data repositories, each associated with a data map of one or more of the plurality of storage locations corresponding to a respective data repository;
a secure server; and
a client device comprising and an application running on the client device and one or more processors, the application communicatively coupled to the secure platform and the trusted file manager system, the application configured to:
create a data repository and an associated data map of one or more of the plurality of storage locations configured to store a plurality of encrypted data fragments of a data object,
identify a storage location of the plurality of storage locations to store a manifest usable to decrypt the plurality of encrypted data fragments, and
associate the data repository with one or more users.

30. The system of claim 29, wherein the data repository is based in part on a storage infrastructure.

31. The system of claim 30, wherein the storage infrastructure comprises one or more of a cloud storage platform, a cloud folder, and a local storage media.

32. The system of claim 29, wherein the application is further configured to generate the data map for the data repository, the data map comprising mapping information for storage of the plurality of encrypted data fragments to the one or more of the plurality of storage locations.

33. The system of claim 29, wherein the application is further configured to select the encryption algorithm for encrypting the data fragments, wherein the manifest generated based in part on the selected encryption algorithm.

34. The system of claim 29, wherein the application is further configured to generate authorization credentials for the one or more users, and provide access to the data repository based on the authorization.

35. The system of claim 29, wherein the client device is configured communicate with the secure server via an application programming interface (API) of the application running on the client device.

36. The system of claim 35, wherein the application running on the client device is executed as one or more APIs of a software development kit (SDK) stored in a memory of the client device.
